(19) United States
(12) Patent Application Publication
(10) Pub. No.: US 2025/0334811 A1
(43) Pub. Date: Oct. 30, 2025

(54) OPTICAL SYSTEM FOR USE IN AUGMENTED REALITY GLASSES

(71) Applicant: Fourier Optics Ltd., Ramat Gan (IL)

(72) Inventors: Shoam SHWARTZ, Ramat Hasharon (IL); Omri BARLEV, Tel Aviv-Yafo (IL); Asaf Akiva CARMEL, Zichron Yaakov (IL); Roy AVRAHAMY, Beer Sheva (IL); Igor TIKHONENKOV, Kiriat Motskin (IL); Uri KOROGODSKY, Ramat Gan (IL); Andreas GEORGIOU, Cambridge (GB); Yuval OFIR, Kfar Ha-Oranim (IL)

(21) Appl. No.: 18/885,945

(22) Filed: Sep. 16, 2024

Related U.S. Application Data
(60) Provisional application No. 63/640,211, filed on Apr. 30, 2024.

(51) Int. Cl. G02B 27/01; G02B 1/00; G02C 7/02

(52) U.S. Cl. CPC G02B 27/0172; G02B 1/002; G02C 7/02; G02B 2027/0178

(57) ABSTRACT

An optical system for use in augmented reality glasses is presented. The optical system defines an eyebox and comprises a lens unit comprising an integral structure formed by a lens and a see-through optical combiner embedded inside the lens being located in an inner part of the lens and enclosed by opposite lens segments of front and rear parts of the lens. The combiner comprises partially-transparent reflectors arranged in a spaced-apart relationship along the inner part and exposed to interaction with input light propagating along a first axis through the inner part of the lens and being indicative of image being projected with a certain exit pupil. The reflectors are inclined with respect to the first axis, to successively interact with the input light and form light reflections providing replication of the exit pupil along a first dimension of the eyebox while maintaining the wavefront curvature of the lens.

### CROSS-REFERENCE TO RELATED APPLICATIONS

The present application claims the priority benefit under 35 U.S.C. § 119 of U.S. Patent Application No. 63/640,211, filed on Apr. 30, 2024, the content of which is hereby incorporated in its entirety by reference.

### TECHNOLOGICAL FIELD

The present disclosure relates to the field of augmented reality (AR) glasses and, more particularly, to combiners for AR glasses.

### BACKGROUND AND BACKGROUND ART

AR headsets use components known as optical combiners to overlay virtual content from displays on top of reality. One of the known approaches for optical combiners used in AR systems is a waveguide-based approach, i.e., utilizing total internal reflection of light propagation through a waveguide. Waveguides, however, are low-efficiency combiners (nits/lumen) requiring brighter displays, leading to larger batteries, challenges in thermal management, and bulkier devices. Another known approach, which is implemented in many low-cost AR headsets, is based on the use of birdbath combiners, made of a curved mirror and beamsplitter, which operate together to directly relay a projected image from a light engine to a user's eye. Compared to the birdbath combiners, waveguides are generally less efficient. However, the use of birdbath combiners, is associated with additional optical elements making the eyepieces bulkier and obscuring the wearer's eyes from the outside world.

A known social aspect of AR glasses is Front Projection, known as “Eyeglow” or Leakage, mostly affecting waveguide-based optical combiners. The eyeglow effect consists of the tendency of the projected image light from the display to leak outward, in the direction of an outside viewer of the user rather than inward, in the direction of the glasses' wearer. This eyeglow is disconcerting and can even pose a security risk if personal information is being viewed.

### GENERAL DESCRIPTION

The present disclosure provides an optical system for use in AR glasses defining an eyebox and including a novel lens unit. The lens unit includes a novel see-through optical combiner configured according to present disclosure to be embedded inside a lens of the lens unit.

The lens may be an ophthalmic (i.e., prescription) lens of standard eyeglasses, i.e., may have a predetermined wavefront curvature according to the eye vision prescription. It should also be noted that such ophthalmic lens may be configured with an optical power profile providing a prescribed optical effect of vision correction. The lens may have a static/constant optical power profile or may be tunable allowing the optical power variation required by changes in the user vision. This can be realized by appending the tunable lenses as will be described further below. Alternatively or additionally, the lens can include any other known feature used in the spectacles' lenses, e.g., can be a permanently tinted, photochromic lens, i.e., the lens that darkens in response to sunlight, electrochromic lens, i.e., the lens darkens in response to electric field, thermochromic, i.e., darkens in response to applied heat.

The see-through optical combiner being embedded in the lens, is configured to provide beam splitter performance implementing replication of an exit pupil of a projector along a single dimension of the eyebox of the optical system, while maintaining the ophthalmic lens form factor (the wavefront curvature).

The technique of the present disclosure provides flexibility in the placement of the projector which provides a virtual image directed to propagate through the see-through optical combiner.

In the following, the see-through optical combiner of the present disclosure is referred to, at times, as “combiner” for simplicity.

As mentioned above, diffractive waveguide-based combiners have relatively low efficiency (up to ˜2% for 30° FOV) and suffer from issues like color and brightness non-uniformity, eye glow, and rainbow effect. Particularly, color uniformity and optical efficiency are two major challenges in a diffractive waveguide combiner. Frequently, a three-waveguide approach (one for each of the R, G, and B colors) or two-waveguide (one for R and one for G and B colors) are used, i.e., each layer having its own grating parameters optimized for a specific color(s). Although this reduces the color nonuniformity across the eyebox, it adds thickness and weight to the combiner, also because the three/two waveguides must have an air gap between them to maintain the requirements of total internal reflection (TIR) condition. Also, the waveguides are typically made from glass, must be of the size of the entire lens, and need to be encapsulated in additional plastic lens (called push-pull lens).

The see-through optical combiner of the present disclosure includes a plurality of partially-transparent reflectors, where each such reflector functions as a multi-band reflector/mirror. The see-through optical combiner of the present disclosure provides a total light efficiency higher by almost an order of magnitude than that of typical waveguide combiners.

The combiner of the present disclosure can be embedded inside a conventional lens, or ophthalmic prescription lens, without air gaps, since the light indicative of the virtual image propagates inside the combiner without the TIR condition. The combiner's embedding inside the lens does not require any additional optics to preserve the lens' prescription, thereby allowing to maintain the original lens form factor. The mentioned above high total light efficiency of the combiner of the present disclosure is achieved while maintaining a high transparency of the combiner to ambient light, allowing natural view of the user's eyes.

The inventors achieve high efficiency and high transparency of the combiner by designing novel Metasurface-based partially-transparent reflectors, whose partial reflectivity is wavelength and angle of incidence dependent. The optical system of the present disclosure defines an eyebox and includes a plurality of such partially-transparent reflectors, embedded inside an inner part of a glasses' lens, being a thin layer (e.g., about 0.5-4 mm thickness), such that successive reflections of light beams indicative of image being projected, freely propagating inside the inner part material, result is one-dimensional exit pupil replication. These successive reflections determine the first dimension of the eyebox of the optical system, whereas the second dimension of the eyebox is defined by the projector optics which may be designed to provide large enough exit pupil in the second dimension, as will be described in detail further below.

Also, the inventors succeeded in providing a uniform brightness over the entire eyebox by configuring the partially-transparent reflectors with different reflection efficiencies of the reflectors (e.g., gradually increasing reflection efficiency of the reflectors in a direction of input light propagation through the combiner), as will be described further below. Further, the combiner of the present disclosure is practically free from rainbow and eye glow effects which are difficult to overcome in other waveguide-based combiners.

According to one broad aspect of the present disclosure, there is provided an optical system for use in augmented reality glasses, the optical system defining an eyebox and comprising a lens unit comprising: an integral structure formed by a lens having a predetermined wavefront curvature according to lens prescription, and a see-through optical combiner embedded inside the lens such that said see-through optical combiner is located in an inner part of the lens being enclosed by opposite lens segments of, respectively, front and rear parts of the lens, said see-through optical combiner comprising a plurality of partially-transparent reflectors arranged in a spaced-apart (e.g., substantially parallel) relationship along said inner part and exposed to interaction with input light propagating along a first axis through said inner part of the lens and being indicative of image being projected with a certain exit pupil, said partially-transparent reflectors being inclined with respect to said axis, such that said partially-transparent reflectors successively interact with the input light, and form light reflections therefrom, thereby providing replication of said exit pupil along a first dimension of the eyebox while maintaining said wavefront curvature of the lens.

The partially-transparent reflectors may be configured with different reflectance efficiencies. For example, the partially-transparent reflectors can be of gradually increasing reflectance efficiency from a first to a last reflector in a direction of the input light propagation along the first axis, to thereby provide uniform illumination of the eyebox.

Each of said partially-transparent reflectors may be configured such that a partial reflectivity of said partially-transparent reflector is wavelength and angle of incidence dependent, thereby partially reflecting light of predetermined wavelengths at predetermined angles towards user's eye.

The partially-transparent reflector may be configured to partially reflect a number N (N≥1) of predetermined discrete wavelengths.

In some embodiments, the partially-transparent reflector has a reflectance efficiency of 10%-25% in a wavelength range of the input light indicative of the image being projected.

The partially-transparent reflector is configured with a one-dimensional or two-dimensional grating pattern.

The partially transparent reflector may comprise a Metasurface structure being a multi-layer structure comprising an intermediate patterned layer having a one-dimensional or two-dimensional grating pattern, said Metasurface structure being adapted to partially reflect a number N (N≥1) of predetermined discrete wavelengths.

For example, the one-dimensional or two-dimensional grating pattern of the partially-transparent reflector, as well as the intermediate patterned layer of the Metasurface structure, may have an arbitrary and/or non-periodic pattern.

The inner part of the lens carrying the partially-transparent reflector/combiner may be of about 0.5-4 mm in thickness.

In some embodiments, the Metasurface structure comprises:
a first layer being a substrate of a predetermined first thickness and a first index of refraction,
a second layer interfacing with the first layer, said second layer being configured as a support layer of a predetermined second thickness and a second index of refraction being higher than the first index of refraction,
a third layer interfacing with the second layer, said third layer being said patterned layer comprising a pattern formed by ridges and grooves of said one-dimensional or two-dimensional grating pattern, wherein said ridges have a third index of refraction higher than said first index of refraction, and said grooves are filled with air, and
a fourth layer interfacing with the third layer, said fourth layer being an overcoat layer of a predetermined fourth thickness and a fourth index of refraction being lower than said second index of refraction.

The Metasurface structure may further comprise a fifth layer interfacing with said fourth layer and being a superstrate layer of a predetermined fifth thickness and fifth index of refraction being lower than the second index of refraction.

In some other embodiments, the Metasurface comprises:
a first layer being a substrate of a predetermined first thickness and a first index of refraction,
a second layer interfacing with the first layer, said second layer being configured as a support layer of a predetermined second thickness and a second index of refraction being higher than the first index of refraction,
a third layer interfacing with the second layer, said third layer being said patterned layer comprising a pattern formed by ridges and grooves of said one-dimensional or two-dimensional grating pattern, wherein said ridges have said second index of refraction, and said grooves are filled with a material having an index of refraction lower than said second index of refraction.

The Metasurface structure may further comprise a superstrate layer interfacing with said third layer and having a predetermined thickness and index of refraction lower than the second index of refraction.

In some embodiments, the lens unit comprises said opposite lens segments configured as matching bonded saw-tooth structures, respectively, such that teeth of the saw-tooth structures of the opposite lens segments are arranged in an interlaced fashion, and wherein each tooth of the saw-tooth structures carries a respective one of the partially-transparent reflectors.

The optical system may further include at least one projector configured and operable to propagate said input light directly along said first axis to be successively incident at an oblique angle on said partially-transparent reflectors.

The at least one projector may comprise a micro display comprising any one of the following: OLED, Micro-OLED, LCD, MicroLED, laser scanner, or DLP.

At least one projector may be either embedded inside the lens, or located outside the lens.

In some embodiments, the at least one projector comprises a lens assembly configured to define said exit pupil, such that the exit pupil has an elongated geometry with a large aspect ratio between said first dimension and a second dimension of the exit pupil, wherein said first dimension is replicated by the combiner and said second dimension defines a second dimension of the eyebox.

The second dimension of the eyebox may be defined by one of the following (i) by the second dimension of the lens assembly of the single projector; or (ii) by second dimensions of lens assemblies of two or more projectors.

The lens segments may be made of material compositions different from those of the inner part containing the combiner.

In some embodiments, the lens segments are made of one or more plastic materials, and the inner part is configured as a glass body with the partially-transparent reflectors formed on the glass body.

In some embodiments, the lens segments are made of one or more plastic materials, and the inner part is configured as a plastic body, made of the same or different plastic material, with the partially-transparent reflectors formed on the plastic body.

According to another broad aspect of the present disclosure, it provides an augmented reality glasses comprising: a pair of optical systems associated with a pair of lenses of the glasses, wherein each optical system comprises:
a lens unit comprising: an integral structure formed by a lens having a predetermined wavefront curvature according to lens prescription, and a see-through optical combiner embedded inside the lens such that said see-through optical combiner is located in an inner part of the lens being enclosed by opposite lens segments of, respectively, front and rear parts of the lens, said see-through optical combiner comprising a plurality of partially-transparent reflectors arranged in a spaced-apart parallel relationship along said inner part and exposed to interaction with input light propagating along a first axis through said inner part of the lens and being indicative of image being projected with a certain exit pupil, said partially-transparent reflectors being inclined with respect to said axis, such that said partially-transparent reflectors successively interact with the input light, and form light reflections therefrom, thereby providing replication of said exit pupil along a first dimension of the eyebox while maintaining said wavefront curvature of the lens; and
at least one optical projector configured and operable to propagate said input light along said first axis to be successively incident at an oblique angle on said partially-transparent reflectors.

As noted above, the partially-transparent reflectors may be configured with different reflectance efficiencies. For example, the partially-transparent reflectors can be of gradually increasing reflectance efficiency from a first to a last reflector in a direction of the input light propagation along the first axis, to thereby provide uniform illumination of the eyebox.

The at least one projector may be embedded inside the respective lens or may be located outside the respective lens.

In some embodiments, the at least one projector comprises a lens assembly configured to define said exit pupil of the respective optical system, such that the exit pupil has an elongated geometry with a large aspect ratio between said first dimension and a second dimension of the exit pupil, wherein said first dimension is replicated by the combiner and said second dimension defines a second dimension of the eyebox.

The second dimension of the eyebox may be defined by the second dimension of the lens assembly of the single projector; or by second dimensions of lens assemblies of two or more projectors.

In some embodiments, the augmented reality glasses comprises a pair of projectors configured and operable to propagate the input light directly along said first axis to be successively incident at an oblique angle on said partially-transparent reflectors, the projectors comprising lens assemblies configured to define together said exit pupil of the respective optical system, such that the exit pupil has an elongated geometry with a large aspect ratio between said first dimension and a second dimension of the exit pupil, wherein said first dimension is replicated by the combiner and said second dimension defines a second dimension of the eyebox.

The projectors may be located in any one of the following regions: temple mount, nose bridge, frame portions above the eyes and close to the eyebrow (frame portions at opposite sides of the nose bridge.

According to yet further broad aspect of the present disclosure, there is provided a see-through optical combiner for use in an optical system comprising a glass or plastic body and a plurality of partially-transparent reflectors arranged in a spaced-apart parallel relationship along said glass or plastic body there inside to successively interact with an input light propagating in a direction through said body, wherein each of said partially-transparent reflectors comprises a Metasurface structure having a grating pattern and being adapted to partially reflect a number N (N≥1) of predetermined discrete wavelengths.

The Metasurface structure may be configured as described above.

According to yet further broad aspect of the present disclosure, there is provided a lens unit for use in an optical system of augmented reality glasses, the lens unit comprising: an integral structure formed by a lens having a predetermined wavefront curvature according to lens prescription, and a see-through optical combiner embedded inside the lens such that said see-through optical combiner is located in an inner part of the lens being enclosed by opposite lens segments of, respectively, front and rear parts of the lens, said see-through optical combiner comprising a plurality of partially-transparent reflectors arranged in a spaced-apart parallel relationship along said inner part and exposed to interaction with input light propagating along a first axis through said inner part of the lens and being indicative of image being projected with a certain exit pupil, said partially-transparent reflectors being inclined with respect to said axis, such that said partially-transparent reflectors successively interact with the input light, and form light reflections therefrom, thereby providing replication of said exit pupil along a first dimension of the eyebox while maintaining said wavefront curvature of the lens.

The partially-transparent reflectors may comprise Metasurface structures, each adapted to partially reflect a number N (N≥1) of predetermined discrete wavelengths.

The manufacturing of the lens unit of the present disclosure includes embedding/encapsulation of a see-through optical combiner (e.g., configured as described above) inside a lens such that the see-through optical combiner is located in an inner part of the lens being enclosed by opposite lens segments of, respectively, front and rear parts of the lens.

In some embodiments, as will be described in detail further below, the see-through optical combiner comprises a glass or a plastic body/plate carrying Metasurface structures, fully or partially embedded inside a plastic resin that is casted from an optically liquid thermoset or optically UV-curable resin.

In other embodiments, the see-through optical combiner comprises a glass or a plastic Metasurface plate (i.e., carrying Metasurface structures) that is appended to front and back plastic/glass lenses (lens segments) using an optical adhesive, as will be described in detail further below.

In yet additional embodiments, the need for casting or bonding lens segments is eliminated by slicing a thick plate of lens material with the see-through combiner already embedded inside and polishing (e.g., using also CNC) the plate to the final lens form, as will be described in detail further below.

Generally, the Metasurface structure design may include interpenetration of the Metasurface features by the optical resin/adhesive, having an index of refraction lower than the index of refraction of the Metasurface features (e.g., grating ridges) and being index-matched with the refractive index of the interfacing substrate/superstrate.

Alternatively, the Metasurface features may be protected via sputtering of a low-index material (e.g., SiO₂) to form a new surface that is then encapsulated with the optical resin.

The Metasurface structures of the present disclosure may be manufactured using any known in the art technology, including and not limited to:
(i) state of the art semiconductor manufacturing technology that includes materials deposition, lithography, etching and liftoff processes, as very well practiced in standard semiconducting Fabs.
(ii) Nanoimprint Lithography (NIL), a replication technique employing pressing a mold with nanoscale features into a thin layer of resist material to transfer the pattern, followed by curing or hardening the resist. The NIL process can be employed in two approaches:
A) Direct NIL, which is a one-step process, particularly effective for manufacturing using high refractive index inorganic nanoparticle-based inks or high index resists to directly form the Metasurface. Relevant materials include, but not limited to, cubic zirconium oxide, titanium oxide (TiO₂), niobium pentoxide, aluminum oxide, diamond, hafnium oxide, tantalum oxide, or zinc oxide, fluorinated tin oxide, indium tin oxide, aluminum zinc oxide, indium zinc oxide, indium tin zirconium oxide, indium gallium oxide, indium gallium zinc oxide, tin oxide, or zinc oxide, or a relevant permanent commercially available optical high refractive index resists or adhesives.
B) NIL in relatively low refractive index resists of many commercial sources (that matches that of the substrate) followed by separation of the mold and deposition/evaporation of a thin layer of high refractive index material to form the upside-down Metasurface and support layer. Relevant materials that can be deposited include, but not limited to, cubic zirconium oxide, titanium oxide (TiO₂), niobium pentoxide, aluminum oxide, diamond, hafnium oxide, tantalum oxide, zinc oxide, tin oxide, fluorinated tin oxide, indium tin oxide, aluminum zinc oxide, indium zinc oxide, indium tin zirconium oxide, indium gallium oxide, indium gallium zinc oxide, or zinc oxide.
(iii) Hot embossing and replication technique involving pressing a mold with nanoscale features into the surface of a thermally softened thermoplastic optical resin, cooling and separation of the mold and followed by deposition/evaporation of a thin layer of high refractive index material to form the upside-down Metasurface and support layer. Relevant materials that can be deposited include, but not limited to, cubic zirconium oxide, titanium oxide (TiO₂), niobium pentoxide, aluminum oxide, diamond, hafnium oxide, tantalum oxide, zinc oxide, tin oxide, fluorinated tin oxide, indium tin oxide, aluminum zinc oxide, indium zinc oxide, indium tin zirconium oxide, indium gallium oxide, indium gallium zinc oxide.

Thus, according to some embodiments, the above-described see-through optical combiner is manufactured by a method comprising: manufacturing a plurality of glass or plastic plates, each carrying the Metasurface structure; stacking the plurality of said plates and bonding them together using an optical adhesive, to form a bonded stack; slicing said bonded stack along an axis inclined at a predetermined angle with respect to a Metasurface plane, into a plurality of combiner plates, each comprising a predetermined set of Metasurface structures. Preferably, the method comprises applying a liquid or vapor surface chemical priming to each of said Metasurface structures prior to said stacking.

According to some other embodiments, the above-described see-through optical combiner is manufactured by a method comprising: manufacturing, by a single molding or casting step, a sawtooth structure, in which each tooth carries a respective Metasurface structure of a predetermined grating pattern, wherein a material composition used for the molding or casting step has a first index of refraction; interpenetrating features of the grating pattern of the Metasurface structures with a material composition having a second index of refraction being higher than the first index of refraction; applying a support layer having the second index of refraction on top of the Metasurface structures.

According to yet further embodiments, the above-described see-through optical combiner is manufactured by a method comprising: manufacturing, by molding or casting, a sawtooth structure using a material composition having a first index of refraction; manufacturing, on top of each tooth of the sawtooth structure, a Metasurface structure comprising a support layer and a respective grating pattern of features, using a material having a second index of refraction being higher than the first index of refraction; interpenetrating feature of the grating pattern and forming a superstrate layer on top of the Metasurface structures using material having an index of refraction lower than the second index of refraction.

In some other embodiments, the see-through optical combiner is manufactured by a method comprising: providing a pair of plates comprising first and second matching saw-tooth structures, respectively, wherein first and second teeth t of the first and second saw-tooth structures respectively are arranged in an interlaced fashion; forming, on each tooth of the saw-tooth structures, a respective one of the Metasurface structures; bonding the first and second saw-tooth structures thereby forming a common array of the Metasurface structures of said first and second saw-tooth structures arranged in the interlaced fashion.

The lens unit of the present disclosure may be manufactured by forming/manufacturing the combiner by any of the above-described method and then encapsulating the combiner in the lens structure.

In some other embodiments, the lens unit may be manufactured by the following method: manufacturing a plurality of plates made of a lens material, each carrying an array of Metasurface structures with a predetermined distance between adjacent Metasurface structures, and a predetermined distance of the array of the Metasurface structure from an edge of a respective one of said plates; stacking the plurality of said plates and bonding them together to form a bonded stack; slicing said bonded stack along a cut axis inclined at a predetermined angle with respect to a Metasurface plane, into a plurality of lens plates; applying a surface treatment to each of the lens plates to obtain a predetermined wavefront curvature of the lens.

In yet further embodiments, the lens is manufactured by: providing a pair of plates made of a lens material and corresponding to the opposite segments of the lens, said pair of plates comprising first and second matching saw-tooth structures, respectively, wherein first and second teeth of the first and second saw-tooth structures respectively are arranged in an interlaced fashion; forming, on each tooth of the saw-tooth structures, a respective one of the Metasurface structures; bonding the first and second saw-tooth structures thereby forming a common array of the Metasurface structures of said first and second saw-tooth structures arranged in the interlaced fashion.

The pair of plates may be configured in accordance with the predetermined wavefront curvature of the lens, or the method may further comprise applying a surface treatment to the pair of plates to obtain a predetermined wavefront curvature of the lens.

### BRIEF DESCRIPTION OF THE DRAWINGS

The patent or application file contains at least one drawing executed in color. Copies of this patent or patent application with color drawing(s) will be provided by the Office upon request and payment of the necessary fee.

In order to better understand the subject matter that is disclosed herein and to exemplify how it may be carried out in practice, embodiments will now be described, by way of non-limiting examples only, with reference to the accompanying drawings, in which:

FIGS. 1A and 1B illustrate the lens unit of the present disclosure for use in the optical system to be incorporated in augmented reality glasses, wherein FIG. 1A shows a side view of the lens unit and FIG. 1B is a 3D model of the lens unit with the see-through combiner embedded in the lens;

FIG. 2 exemplifies some typical dimensions of the see-through optical combiner of the present disclosure embedded in the lens;

FIGS. 3A to 3B illustrate exemplary optical designs and ray tracing of the optical system according to the principles of the present disclosure;

FIG. 4 exemplifies a partially-transparent reflector of the present disclosure (for use in the see-through optical combiner) implemented as a subwavelength grating Metasurface;

FIGS. 5A to 5F illustrate calculations of a subwavelength grating Metasurface of FIG. 4, providing two resonant p-polarized wavelengths with high reflection efficiency, where the grating material is Silicon Nitride (Si₃N₄), wherein FIGS. 5A and 5B show, respectively, reflection efficiency of the zero order as a function of the free incidence angle and the material incidence angle in the visible spectral range; FIGS. 5C and 5D show, respectively, the transmission efficiency of the zero order as a function of the free incidence angle and the material incidence angle in the visible spectral range; and

FIGS. 5E and 5F show, respectively, reflection and transmission efficiencies of the zero order at incidence angle of 45°;

FIGS. 6A to 6F illustrate calculations of the subwavelength grating Metasurface of FIGS. 5A to 5F, providing two resonant s-polarized wavelengths with high reflection efficiency, wherein FIGS. 6A and 6B show, respectively, reflection efficiency of the zero order as a function of the free incidence angle and the material incidence angle in the visible spectral range; FIGS. 6C and 6D show, respectively, the transmission efficiency of the zero order as a function of the free incidence angle and the material incidence angle in the visible spectral range; FIGS. 6E and 6F show, respectively, reflection and transmission efficiencies of the zero order at incidence angle of 45°;

FIGS. 7A to 7D show calculations of a subwavelength grating Metasurface described in FIG. 4, providing two resonant wavelengths with high reflection efficiency, where the grating material is Niobium pentoxide (Nb₂O₅), wherein FIG. 7A shows the reflectance of the s-polarized light, FIG. 7B shows the transmittance of the s-polarized light, FIG. 7C shows the reflectance of p-polarized light, and FIG. 7D shows the transmittance of the p-polarized light;

FIGS. 8A to 8D show, respectively, the reflectance of the s-polarized light (FIG. 8A), the transmittance of the s-polarized light (FIG. 8B), the reflectance of p-polarized light (FIG. 8C), and the transmittance of the p-polarized light (FIG. 8D), wherein the parameters used in the calculations are different from the respective parameters of FIGS. 7A to 7D only by the height of the grating ridge, h_{g};

FIGS. 9A to 9F show results of calculation of reflection (FIGS. 9A to 9C) and transmission (FIGS. 9D to 9F) for s-polarization for, respectively, three different incidence angles: θᵢₙ=[41.5°, 45°, 48.5°] demonstrating the dependence of the resonant wavelength of reflection on the incidence angle;

FIG. 10A shows a side view of an exemplary Metasurface having a pattern of a 1D grating with square ridges and grooves between them and configured to serve as a multi-wavelength selective band pass reflector, FIG. 10B shows the calculated zero-order transmission of the Metasurface of FIG. 10A as a function of incidence angle and wavelength, FIG. 10C shows the average transmittance efficiency for s- and p-polarizations for an angle of incidence of 45°, and FIG. 10D shows the reflectance efficiency at an angle of incidence of 45° for s- and p-polarizations and the emission spectrum of a green source;

FIGS. 11A and 11B show examples of two-dimensional patterns of the partially transparent Metasurface structures of the present disclosure, wherein FIG. 11A shows a Metasurface configured with a pattern of square/rectangular grooves within a grating layer material, and FIG. 11B shows a Metasurface structure configured with a pattern of round pillars; The grooves in FIG. 11A and the inter-pillar spaces in FIG. 11B may be either filled with air (requiring thus an overcoat layer) or filled with a material having an index of refraction lower than the index of refraction of the grating layer material/pillars;

FIG. 12A shows schematically a combiner of the present disclosure including a single partially-transparent reflector embedded in glass (SiO₂), indicating the incidence angle of light inside the glass and the angle of refraction of light towards the eye, FIG. 12B shows the relative orientation of the Metasurface and eye frames, FIG. 12C shows the definition of FOV angles θ_{X}, θ_{Y} defining the direction of the outgoing light beam relative to the eye frame and spherical angles θ_{S}, θ_{S} defining the direction of the incident beam within the glass material relative to the Metasurface;

FIGS. 13A and 13B show the efficiency of the zero-order reflection (S-polarization) as a function of FOV angles for a tilt angle α_{MS}=45° (FIG. 13A) and α_{MS}=47° (FIG. 13B); FIG. 13C shows the normalized spectral density of a μLED source used for the FOV and the averaged data calculations of FIGS. 13A and 13B; FIGS. 13D and 13E show, respectively, the material spherical angles θ_{S} and θ_{S} as a function of FOV angles θ_{X}, θ_{Y}, for the wavelength λ=530 nm;

FIGS. 14A to 14K show averaged reflection/transmittance efficiencies calculated for several types of parameters, wherein FIGS. 14A and 14B show the efficiency of the zeroth reflected order for s-polarization (FIG. 14A) and p-polarization (FIG. 14B) as a function of wavelength and polar incidence angle within the material. The azimuthal incidence angle is 0 deg.; FIG. 14C shows the average (over polarizations) transmitted efficiency of the zeroth order, (T0S+T0P)/2; FIGS. 14D and 14E show results of averaging over wavelength λ and widths {wₓ, w_{y}} for, respectively, s- and p-polarizations; FIGS. 14F and 14G show results of averaging over widths {wₓ, w_{y}} for, respectively, s- and p-polarizations, and for a constant wavelength of 530 nm; FIGS. 14H and 14I show results of averaging over wavelength λ and depth (height), h_{g}, of the grating ridges; FIGS. 14J and 14K show results of the average (over polarizations) transmitted efficiency of the zeroth order, (T0S+T0P)/2 where averaging is performed over wavelengths λ and widths {wₓ, w_{y}} (FIG. 14J) and over wavelengths λ and depths h_{g} (FIG. 14K);

FIGS. 15A to 15D show results of rainbow analysis of the Metasurface of the present disclosure from the front side (i.e. facing the environment), wherein FIG. 15A schematically shows the rainbow effect on the front side of the lens, FIG. 15B shows Zemax simulation of the rainbow effect for free space angle of incidence (AOI) of ±80° and λ=450 nm; FIGS. 15C and 15D show results of RCWA simulation of two mirrors with combined 1^{st} diffraction order, wherein FIG. 15C shows the transmitted light intensity (T₋₁·T₋₁) to the outside, and FIG. 15D shows the respective total transmitted photopic intensity (T₋₁·T₋₁);

FIGS. 16A to 16D show results of rainbow analysis of the Metasurface of the present disclosure from the back side (i.e. facing the user), wherein FIG. 16A schematically shows the rainbow effect on the back side of the lens, FIG. 16B shows Zemax simulation of the rainbow effect for free space angle of incidence (AOI) of ±80° and λ=450 nm, FIGS. 16C and 16D show results of RCWA simulation of two mirrors with combined 1^{st} diffraction order, wherein FIG. 16C shows the transmitted light intensity (T₋₁·R₀) towards the user's eye and FIG. 16D shows the respective total transmitted photopic intensity (T₋₁·R₀);

FIG. 17A illustrates three light paths that may be responsible for the occurrence of eye glow effect;

FIGS. 17B to 17E show calculated distribution of light intensity due to eye glow for various light paths as a function of incidence angle for a typical visible wavelength range of a projector, wherein FIGS. 17B and 17C show, respectively, calculation results of eye glow for the first path in absolute and photopic units of light intensity, and

FIGS. 17D and 17E show, respectively, the calculation results of eye glow for the second path in absolute and photopic units of light intensity;

FIG. 18A shows a design of an ideal single projector;

FIG. 18B shows a projector where energy loss results from a smaller projector f-number;

FIG. 18C shows a design with N projectors (N≥1), each having a separate screen;

FIGS. 18D and 18E show an optical system design based on two-projectors approach, wherein FIG. 18D shows the ray tracing defining the eyebox created by the two projectors, and FIG. 18E shows schematically an optical system including two projectors;

FIG. 19 shows, by way of a flow diagram, a manufacturing method of the optical system of the present disclosure;

FIGS. 20A to 20C show, in a self-explanatory manner, an exemplary flow diagram of various steps of the manufacturing method described in FIG. 19;

FIG. 20D shows an exemplary flow diagram of manufacturing method including stacking multiple two-side patterned plates with spacers in between and angular wire-sawing;

FIGS. 21A to 21E show methods to integrate the see-through combiner into a lens;

FIGS. 22A and 22B show examples of a manufacturing method of the see-through optical combiner of the present disclosure, based on a saw-tooth structure;

FIG. 23 illustrates various manufacturing steps described in FIG. 22A; and

FIGS. 24A to 24D illustrate examples of a manufacturing method of the see-through optical combiner of the present disclosure, based on interlacing a pair of saw-tooth structures.

### DETAILED DESCRIPTION OF EMBODIMENTS

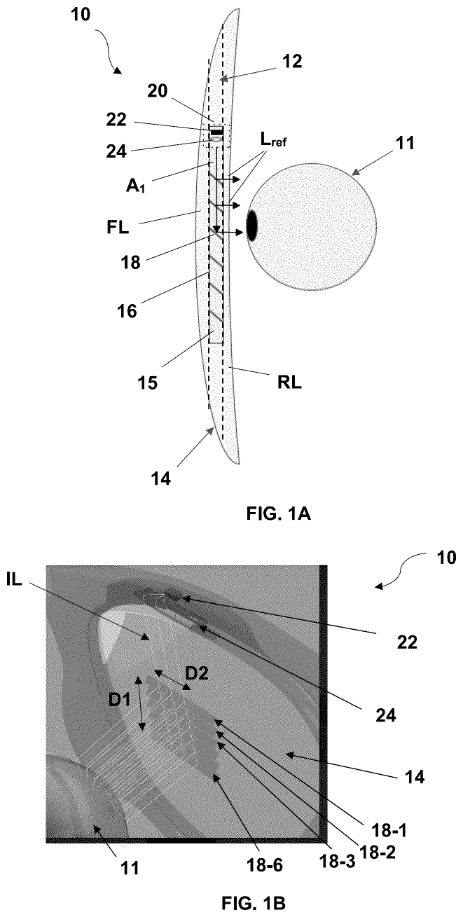

Reference is made to FIGS. 1A and 1B exemplifying an optical system 10 of the present disclosure for use in augmented reality glasses. More specifically, the figures exemplify a lens unit 12 of the optical system 10 configured according to the technique of the present disclosure. FIG. 1A shows a side view of the lens unit and FIG. 1B shows a 3D model of the lens with a see-through optical combiner embedded in the lens.

The optical system 10 is configured to define an eyebox of the augmented reality system. The optical system includes a lens unit. The lens unit 12 includes an integral structure formed by a lens 14 predetermined wavefront curvature defined by the lens' prescription and a see-through optical combiner 16 embedded inside the lens 14. The see-through optical combiner 16 is located in an inner part 15 of the lens 14 enclosed by opposite lens segments of, respectively, front FL and rear RL parts of the lens.

The lens is configured as a typical spectacles' lens. The lens 14 may be an ophthalmic lens for vision correction (having a wavefront curvature defined by the prescribed optical power profile of the lens' prescription), and/or may have a photochromic lens functionality.

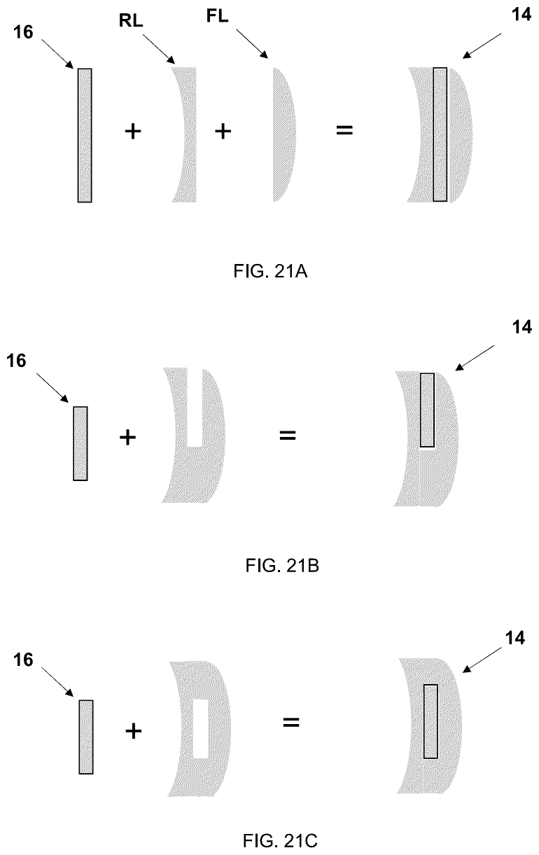

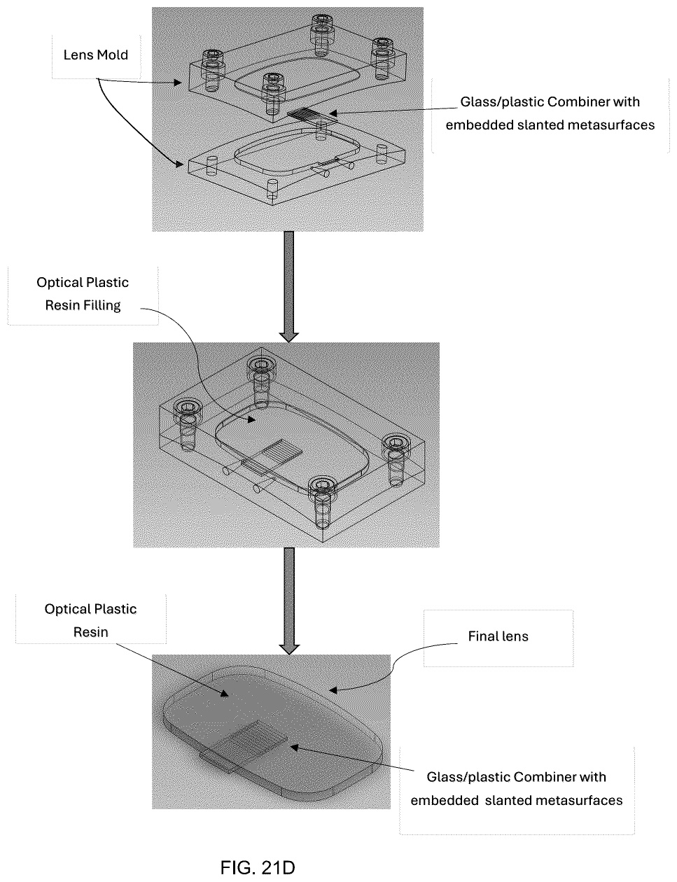

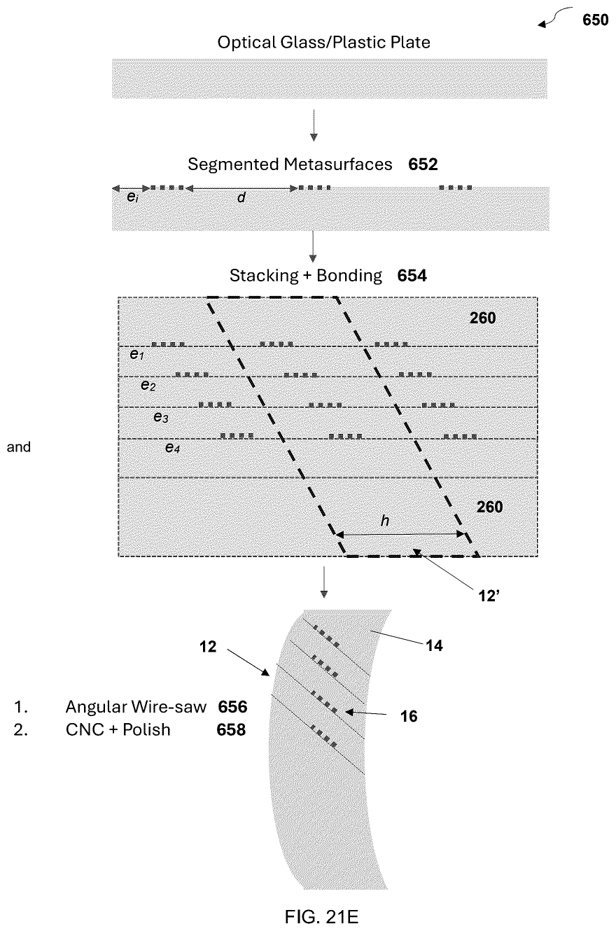

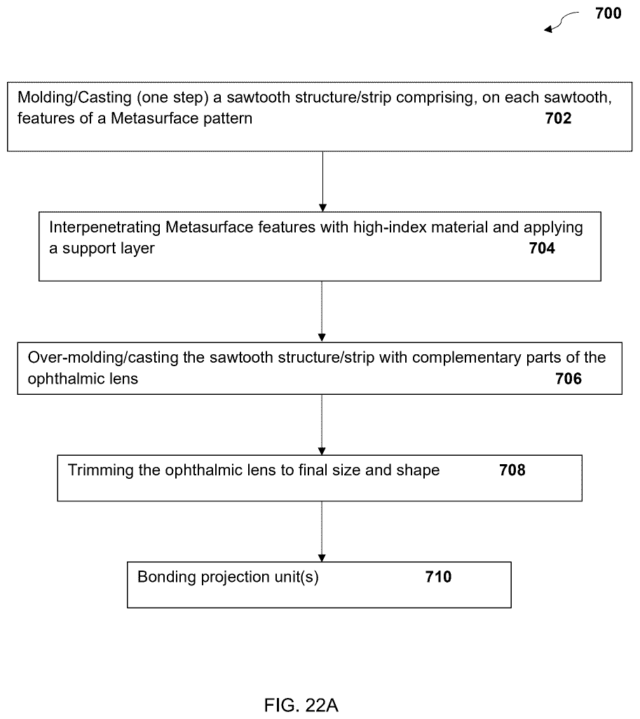

As noted above, the ophthalmic properties of the lens may be static or variable (tunable). As will be described further below, the suitable technique to realize this option is by manufacturing the lens unit with the embedded combiner using the manufacturing method described below with reference to FIG. 21A.

Alternatively, or additionally, the lens may include any other known feature used in the spectacles' lenses, e.g., may be a permanently tinted, photochromic lens, i.e., the lens that darkens in response to sunlight, electrochromic lens, i.e., the lens darkens in response to electric field, thermochromic, i.e., darkens in response to applied heat.

In the description below, the lens 14 is at times referred to as “ophthalmic lens”. However, it should be understood that the principles of the present disclosure are not limited to this example.

It should be noted that the manufacturing of such enclosed inner part carrying the combiner 16 inside the lens can be readily performed by standard (UV/heat curable) casting process, where liquid material (i.e. plastic material) of the lens is poured into a pre-formed mold.

The optical system 10 includes also at least one projector 20, which may be also embedded in the lens 14 (as shown in FIG. 1A) or may be located outside the lens 14, as will be described further below. The projector typically includes a virtual image display 22 and a projector optics 24 defining an exit pupil of the projector 20. The projector 20 operates to direct light indicative of the virtual image onto the combiner 16. The latter is configured to replicate this exit pupil along a first dimension of the eyebox, while maintaining the wavefront curvature of the lens 14.

The see-through optical combiner 16 includes a plurality of partially-transparent reflectors 18 arranged in a spaced-apart relationship along a body 15 of the combiner forming the inner part of the lens 14, when integrated with the lens, i.e., enclosed by the opposite lens segments, as described above. In the present non-limiting example of

FIGS. 1A and 1B, the combiner 16 is shown including six partially-transparent reflectors, 18-1, 18-2 . . . , 18-6, as marked in FIG. 1B.

The partially-transparent reflectors 18 arranged in a spaced-apart parallel relationship along the inner part 15 are exposed to interaction with input light IL propagating along a first axis A1 through the inner part of the lens 14. The input light IL is indicative of an image (virtual image) being projected to the eye of the user and is characterized by a certain exit pupil initially defined by the optics of projector 20, as noted above.

The partially-transparent reflectors 18 are inclined with respect to the first axis A1 and successively interact with the input light IL to form light reflections L_{ref} therefrom, i.e., each partially transparent reflector transmits a part of the incident light towards a successive reflector and reflects a part of the incident light in an output direction towards the user's eye. This provides the exit pupil replication along a first dimension, e.g., D1 in FIG. 1B, while maintaining (substantially not affecting the lensing property of the lens 14, i.e., the wavefront curvature of the lens.

The partially-transparent reflectors may be configured with different reflectance efficiencies, e.g., to thereby provide a uniformly illuminated eyebox. For example, the reflectance efficiency of the partially transparent reflectors gradually increases from the first to the last reflector in a direction of the light propagation through the combiner, to thereby provide a uniformly illuminated eyebox.

For example, input light IL from the projector 20 enters the system and strikes the first tilted, partially-transparent reflector 18-1 at an oblique angle. Here, the light gets split: a portion/part of the light is reflected towards the user's eye, forming the augmented reality image (i.e., superposition of the virtual image with the scene viewed by the user's eye). The remaining portion part of light being incident on said reflector 18-1 is transmitted through this reflector and continues propagation along axis A1 to be incident on the next reflector 18-2 in the cascade. Interaction of light with each subsequent partially transparent reflector results in that the light is partially reflected (contributing to the AR image) and partially transmitted onward.

This cascading partial reflection process provides a large eyebox, and is known as “exit pupil expansion” (EPE) or “exit pupil replication” (EPR). The eyebox refers to the area within which the user can move his/her eye while still seeing a clear, undistorted AR image. Traditional designs often have a limited eyebox, requiring users to hold their head very still.

The projector 20 is configured and operable to propagate the input light IL, indicative of the image being projected to the eye 11, directly along the first axis A₁ to be incident on the partially-transparent reflectors 18 at an oblique angle because of inclined orientation of the reflectors. It should be noted that projector optics 24 typically includes one or more lenses, and may also include one or more of such optical elements as filter(s), polarizer(s), etc.

In some embodiments, the projector optics includes a projector lens unit 24 including a lens assembly configured to define the exit pupil having an elongated geometry with a large aspect ratio between the first dimension and a second dimension of the exit pupil. As noted above, the first dimension is that along axis A1 along which the reflectors 18 are arranged (e.g., along D1 in FIG. 1B) and is replicated by the see-through optical combiner 16, and the second dimension of the exit pupil defines a second dimension (e.g., along D2 in FIG. 1B) of the eyebox.

It should be noted that, contrary to known in the art optical systems utilizing waveguides, the optical system 10 of the present disclosure does not require total internal reflection (TIR) of the input light along its propagation within the combiner (and thus within the lens 14) between the successive partially-transparent reflectors.

TIR is a condition to confine light within a waveguide, such that the propagation angle of the guided light is larger than the critical angle for total internal reflection (TIR). Optical combiners utilizing waveguides require air gaps to be provided at both sides of the waveguide layer/body and requires provision of specialized optics (e.g., converging and diverging lenses) in addition to the prescription ophthalmic lens, adding thus complexity and bulk to the optical system.

The optical system 10 of the present disclosure is configured and operable such that light from the projector 20 is freely propagating within the lens, i.e., within the material of the ophthalmic lens 14 on its way to the combiner (as the case may be), and within the material of the combiner's body 15. The see-through optical combiner 16 of the present disclosure is embedded/integrated inside the ophthalmic lens such that the form factor of the lens is maintained and total added weight to the glasses may be kept <<1 gr.

FIG. 2 exemplifies some typical dimensions of the see-through optical combiner 16. In particular, the distance between two adjacent partially transparent reflectors 18 may be about 2 mm, the width of each partially transparent reflector 18 may be about 1.4 mm, thus adding less than 1 mm of thickness to the lens 14 when the partially transparent reflectors 18 are inclined at 45° with respect to the axis of propagation of the input light IL.

As already mentioned above, eyebox is one of the metrics used to evaluate the performance of an augmented reality system (display) and represents the spatial volume within which the user can view the displayed image. It is crucial to provide a sufficiently large viewing area within the eyebox to accommodate the natural diameter of the human eye's pupil. Moreover, the eyebox should also allow for a margin to accommodate normal eye rotations during typical usage, as well as differences in inter-pupillary-distance (IPD) between users.

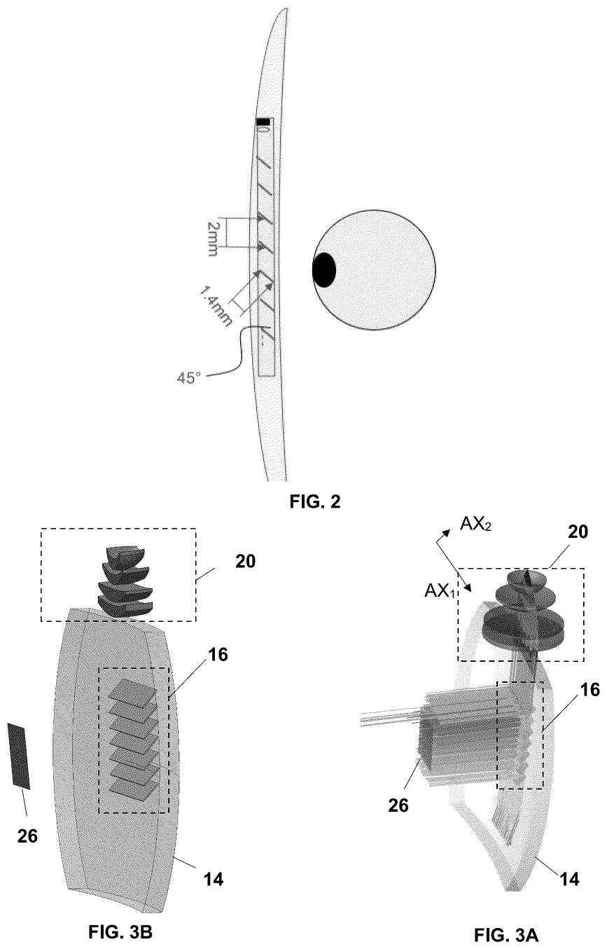

FIGS. 3A and 3B illustrate some examples of the configurations of the optical system 10 of the present disclosure including the lens unit 12 (lens 14 with the combiner 16) and projector 20. In these non-limiting examples, the projector is configured as a four-element display engine (projector) 20. The inventors designed and modelled the system in OpticStudio (Zemax).

FIG. 3A shows the display engine 20 with four full-size lenses, whereas FIG. 3B shows the display engine 20 where all the lenses are cut along two edges to thereby reduce the size and the weight of the projector. FIG. 3A illustrates a ray tracing example of the optical system 10 where some rays exiting the optical combiner 16 are missing the eyebox 26. It should be noted that in other embodiments, more compact display engines may be designed.

As shown in FIG. 3A, the projector 20 is configured for efficient light use by designing the projector optics with a relatively large numerical aperture (NA) along one axis (e.g., AX₁). A large NA in one direction enables to create a wider eyebox. However, the projector's exit pupil (the point/region where light exits the projector) is small along the other axis (e.g., AX₂). This allows for efficient light collimation by the cascaded partially transparent reflectors. Thus, by using a small exit pupil and a large NA in one direction, the projector can create a light beam suitable for being multiplied by the partially transparent reflectors, ultimately leading to a wider eyebox for the user.

Exemplary reflection/transmission properties that can be achieved with the partially-transparent reflectors of the present disclosure are shown in Table 1. The eyebox provided by the optical system 10 of FIGS. 3A and 3B is 10×10 mm.

TABLE 1

| | Mirror Number | | | | | | |
|---|---|---|---|---|---|---|---|
| | 7 | 6 | 5 | 4 | 3 | 2 | 1 |
| Mirror | 25.00% | 20.00% | 16.67% | 14.29% | 12.50% | 11.11% | 10.00% |
| Efficiency | | | | | | | |
| Reflected | 10.00% | 10.00% | 10.00% | 10.00% | 10.00% | 10.00% | 10.00% |
| Transmitted | 30.00% | 40.00% | 50.00% | 60.00% | 70.00% | 80.00% | 90.00% |
| Transparency | 87.50% | 90.00% | 91.67% | 92.86% | 93.75% | 94.44% | 95.00% |

This table shows that by varying the mirror efficiency of the partially-transparent reflectors, e.g., by gradually increasing the mirror efficiency from the first to the last reflector in a direction of the light propagation through the combiner, a uniformly illuminated eyebox can be achieved, as can be judged from the uniform reflected power across the plurality of the partially transparent reflectors (i.e., a uniform reflected power of 10% of mirrors 1 to 7) presented in the table. Thus, the total light that is reflected in the direction of the user by the optical combiner 16 is about 70% of the in-coupled light. If it is assumed that about 50% of the light lands outside the 10 mm×10 mm eyebox, then the brightness decreases from the display panel to the eyebox by about 60%. A detailed efficiency breakdown to various loss factors of the combiner of the present disclosure is described further below.

Generally, the partially-transparent reflectors may be implemented as partially reflecting dielectric or metal mirrors. Preferably, the partially-transparent reflector is configured with a partial reflectivity which is wavelength and angle of incidence dependent, thereby partially reflecting light of predetermined wavelengths at predetermined angles towards user's eye. In some embodiments, the partially-transparent reflectors may be implemented as traditional bandpass filters (for example, thin film layers) configured to function as bandpass reflectors. Specifically, the coatings over the angled glass serving as the base of the bandpass filters may be configured to reflect specific projector wavelengths (typically red, green, and blue bands) with desired bandwidth and efficiency.

It is noted that, in general, the reflection coatings may have varying reflection efficiencies (0.1% to 100%), as also exemplified in Table 1.

The partially-transparent reflector is preferably configured to partially reflect at least one predetermined discrete wavelength. The reflectance efficiency of the partially transparent reflector may be about 10%-25% in a wavelength range of the input light indicative of the image being projected.

In some embodiments, the partially-transparent reflectors may be implemented as Metasurface bandpass filters/reflectors. The Metasurfaces may be placed on an angled glass to reflect specific projector wavelengths, offering similar customization options as traditional bandpass filters. These Metasurfaces can be either dielectric or plasmonic (metal-based) or any other type and materials of Metasurface.

Preferably, the partially-transparent reflector is configured with a one-dimensional or two-dimensional grating pattern, implemented using a Metasurface-based partially-transparent reflectors having novel configuration according to the present disclosure. Such partially-transparent reflector includes a Metasurface structure which provides almost an order of magnitude higher efficiency as compared to optical combiners based on surface relief grating (SRG) or geometric waveguides.

More specifically, the Metasurface structure is configured as a multi-layer structure including a patterned layer having a one-dimensional or two-dimensional grating pattern and being adapted to partially reflect a number N (N≥1) of predetermined discrete wavelengths. The pattern is in the form of ridges and grooves of the one dimensional or two-dimensional grating pattern. Such patterned layer is located on top of a support layer, which in turn is located on top of a substrate. The thicknesses and refractive indices of the layers are properly selected to optimize the performance of the Metasurface structure. The support layer has a refractive index higher than that of the substrate; and the ridges of the patterned layer have a refractive index higher than that of the substrate and may be the same or different from the refractive index of the support layer.

In some embodiments, the grooves are filled with air. In this case the Metasurface structure also includes an overcoat layer located on top of the patterned layer and having index of refraction lower than that of the support layer. In some other embodiments, the grooves are filled with a material having an index of refraction lower than that of the support layer, in which case there is no need for the overcoat layer.

In some embodiments, the Metasurface structure may further include a superstrate layer which either directly interfaces with the patterned layer (in case there is no overcoat layer) or located on top of the overcoat layer if used. The superstrate layer has similar index of refraction to that of the substrate layer, being lower than that of the support layer.

It should be noted that the distinction between the substrate and superstrate layers in this disclosure is formal and is used for the sake of clarity of presentation. As will be described further below, the same material may be used for the substrate and the superstrate. Furthermore, as will be described further below, in the process of manufacturing of the see-through optical combiner 16 of the disclosure, the optical plates, each carrying a Metasurface structure may be stacked one on top of the other such that the substrate of the upper plate serves as the superstrate of the lower plate.

In the following, the embodiments including partially-transparent reflectors implemented as the Metasurface structures according to the present disclosure performing bandpass filter function are described in detail.

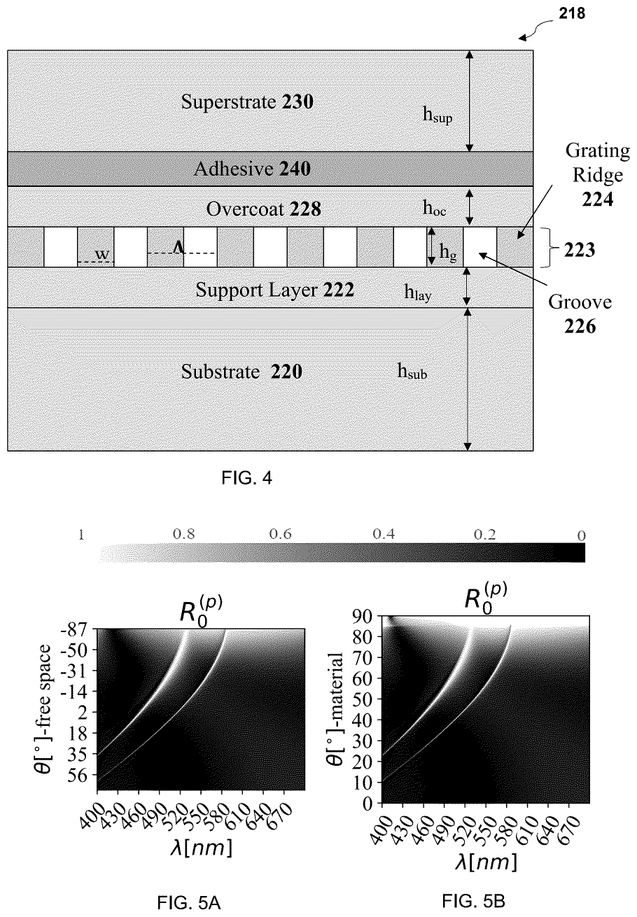

FIG. 4 is a cross section view of an exemplary Metasurface structure 218 having a grating pattern of a 1D grating with square ridges and grooves between them and configured to serve as a multi-wavelength selective bandpass reflector. The Metasurface structure 218 includes a substrate layer 220 made of material of refractive index R1 and having a height (thickness) h_{sub}, a support layer 222 made of material of refractive index R2 such that R2>R1, and having height (thickness) h_{lay}, and a patterned layer 223 having grating ridges 224 and grooves 226 of height h_{g}, where ridges are made of material having refractive index R3 such that R3>R1. In this non-limiting example, the grooves are filled with air and therefore the Metasurface structure 218 also includes an overcoat layer 228 of height (thickness) hoc made of material having refraction index R4 such that R4<R2. Also, optionally provided is a superstrate layer 230 of height (thickness) hₛᵤₚ made of material having refraction index R5 such that R5<R2, coupled to the structure by adhesive layer 240.

It should be noted that typically, the Metasurface structures of the present disclosure may be manufactured from two or three different materials only. For example, the substrate 220, the superstrate 230 and the grooves 226 may be made from glass (SiO₂), where the respective refractive indexes satisfy the condition that R1=R5=R_{low} (no overcoat is required if grooves are filled with material). Typically, when an overcoat is used, it satisfies the condition that R4=R1=R5=R_{low}. The support layer 222 and the ridges may be made out of the same high-index material satisfying the condition that R2=R3=R_{high}, e.g., Niobium pentoxide (Nb₂O₅). In some other embodiments, the substrate 220 may be made of glass and the grooves 226 may be filled with index-matched resin/optical adhesive, satisfying R1=R5=R_{low}. Therefore, throughout the description below the term “low-index” should be understood as a relative term, i.e., lower refractive index as compared to R2 and R3. Accordingly, the term “high-index” should be understood as a relative term as well, i.e., higher refractive index as compared to R1, R4, and R5.

The grating pattern in layer 223 is characterized by a ridge width w and a grating spatial period A. For example, the materials used for the various layers of the Metasurface structure include glass substrate 220 (e.g., Corning® EAGLE XG® Glass commercially available from Corning Inc.), Si₃N₄ or Nb₂O₅ for the support layer 222 and ridges 224, and fused silica (SiO₂) or Sol Gel for the overcoat 228 and superstrate 230.

In some embodiments, the material of the substrate 220 and/or the superstrate 230 may be an optically clear thermoset resin, similar to resins used for the manufacturing of the ophthalmic lens. Also, in some embodiments, the support layer 222 and/or the ridges 224 may be made of a plastic material. As noted above, if air is filling the grooves 226, the overcoat layer 228 is used. However, if the grooves 226 are filled with a material having refractive index R6 lower than refractive index R3 of the grating ridge 224 material, the overcoat is not needed. For example, in embodiments where grooves 226 are filled with certain material, the filling material may be SiO₂ applied by evaporation, or Sol Gel, or optical adhesive index-matched with the substrate 220/superstrate 230.

In other embodiments, where the grooves 226 are left filled with air, the Metasurface features (i.e., the ridges 224), are protected via angular directional sputtering (e.g., SiO₂) to form a new surface, i.e., the overcoat layer 228, that is then bonded to the superstrate layer 230 e.g., while a bonded stack of Metasurfaces is formed, as will be described in detail further below.

A possible physical mechanism behind the reflection involves coupling to quasi-bound states in the continuum (BIC) modes. This physical phenomenon is responsible for creating a resonance which allows only for selected wavelengths to be reflected by the Metasurface.

The Metasurface structure of the present disclosure is preferably designed such that at least 95% transparency is achieved in the visible spectrum (to allow visibility of the outer world), whereas high reflection efficiency is achieved for selected wavelengths of the image being projected forming the projected virtual image.

In some embodiments, the symmetry in the refraction indices of the substrate and superstrate layer may facilitate the coupling to the BIC modes and thereby increase reflection efficiency of the source while maintaining the high transparency to light coming from the outside world.

In some other embodiments, such symmetry in refraction indices is not required to achieve high reflectivity, however, it may be accompanied by somewhat reduced transparency.

In the following, the results of calculations of various properties of the Metasurface-based partially transparent reflectors of the present disclosure conducted by the inventors are presented. The calculations were performed using RCWA (Rigorous Coupled-Wave Analysis).

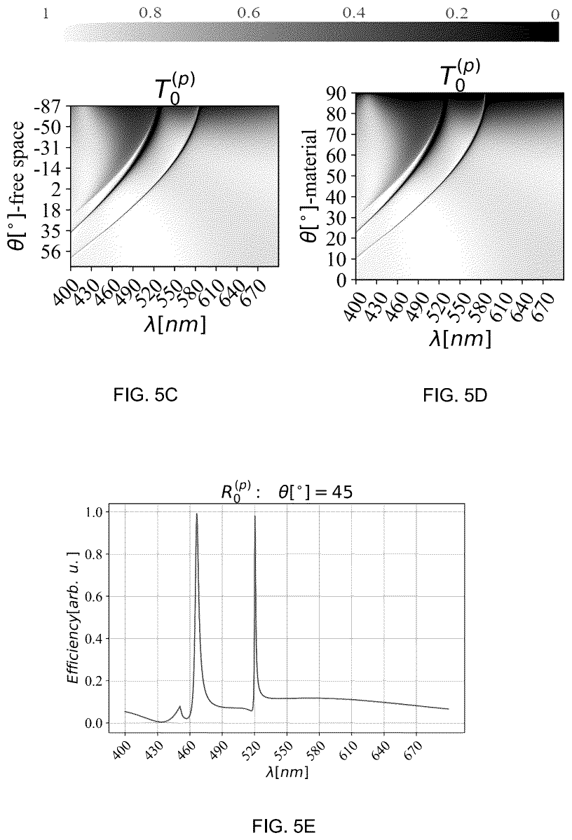

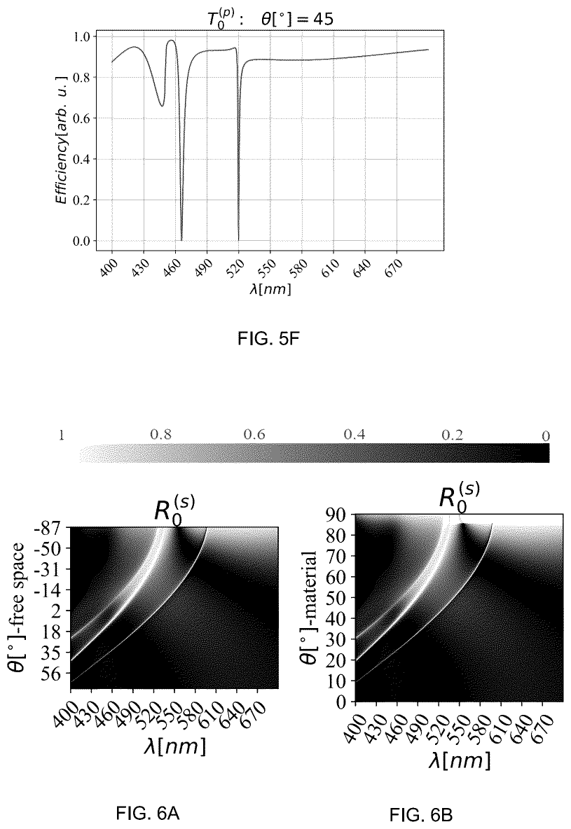

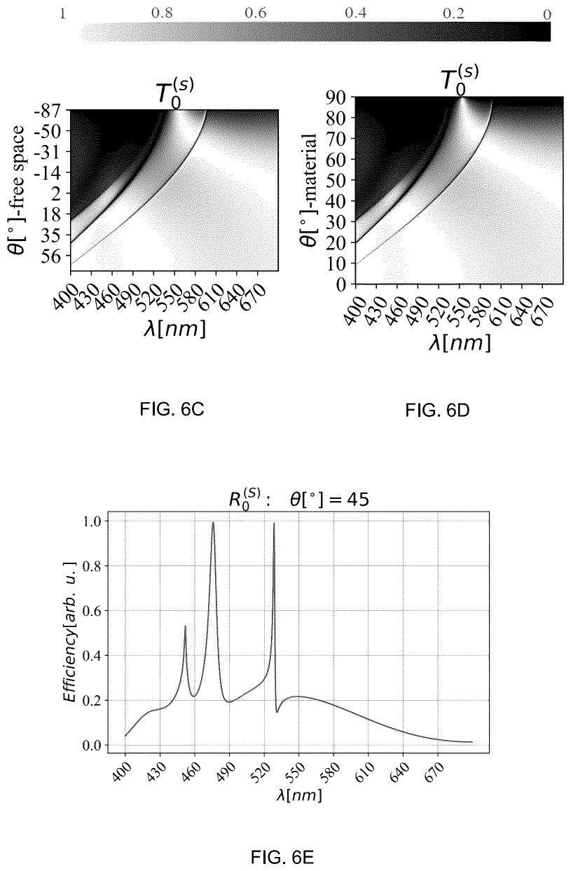

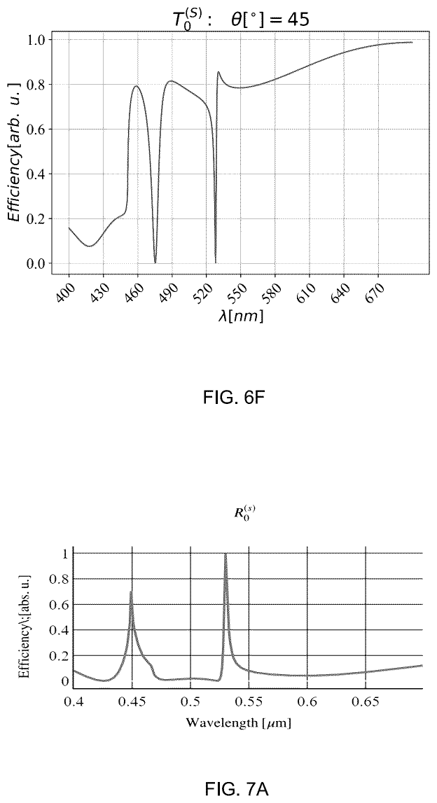

FIGS. 5A to 5F and FIGS. 6A to 6F show results for resonant reflection in the blue and green wavelength bands, using a single die etched to the dimensions shown in

Table 2, which also indicates the materials used for the various layers of the Metasurface structure.

TABLE 2

| Layer | Material | Parameter | Value [μm] |
|---|---|---|---|
| Substrate | Corning ® EAGLE | h_{sub} | >100 |
| | XG ® Glass | | |
| Support Layer | Si₃N₄ | h_{lay} | 0.242 |
| Grating | Si₃N₄ | h_{g} | 0.186 |
| Filling | Air | | |
| Overcoat | Corning ® EAGLE | hₛᵤₚ + h_{oc} | >100 |
| Superstrate | XG ® Glass | | |
| N/A | N/A | Λ | 0.18 |
| N/A | N/A | w | 0.09 |

FIGS. 5A and 5B show, respectively, the reflectivity of the zero-order of the Metasurface structure for p-polarized incident light as a function of incidence angles for the free space (FIG. 5A) and (superstrate) material (FIG. 5B) within the visible spectrum of the projector. The support layer 222 and the grating ridges 224 are made of Silicon nitride (Si₃N₄).

FIGS. 5C and 5D show, respectively, the transmittance of the zero-order of the Metasurface for p-polarized incident light as a function of incidence angles for the free space (FIG. 5C) and (superstrate) material (FIG. 5D) within the visible spectrum of the projector. FIGS. 5E and 5F show, respectively, the reflectance and the transmittance extracted from FIGS. 5B and 5D for angle of incidence of 45° within the superstrate material. The figures show that two narrow bands, high efficiency reflection maxima are achieved on a single die (i.e. Metasurface) at blue (˜470 nm) and green (˜520 nm) wavelengths.

FIGS. 6A and 6B show, respectively, the reflectivity of the zero-order of the same Metasurface structure as in FIGS. 5A to 5F, but for s-polarized incident light as a function of incidence angles for the free space (FIG. 6A) and (superstrate) material (FIG. 6B) within the visible spectrum of the projector. FIGS. 6C and 6D show, respectively, the transmittance of the zero-order of the Metasurface for s-polarized incident light as a function of incidence angles for the free space (FIG. 6C) and (superstrate) material

(FIG. 6D) within the visible spectrum of the projector. FIGS. 6E and 6F show, respectively, the reflectance and the transmittance extracted from FIGS. 6B and 6D for angle of incidence of 45° within the superstrate material. The figures show that high efficiency reflection may be achieved also for s-polarization in the two (blue and green) wavelength bands. It should be noted that typically, RGB sources have about 30 nm wide spectral lines in each of R (red), G (green), and B (blue) ranges (e.g., μLED sources), thus the Metasurface structure of the present disclosure can be designed to have a sufficient overlap with the emission spectrum of the image source for both polarizations.

Similar results can be achieved with different materials for the support layer 222 and the grating ridges 224 (refer to FIG. 4), for example with Niobium pentoxide (Nb₂O₅). The parameters for calculations are shown in Table 3.

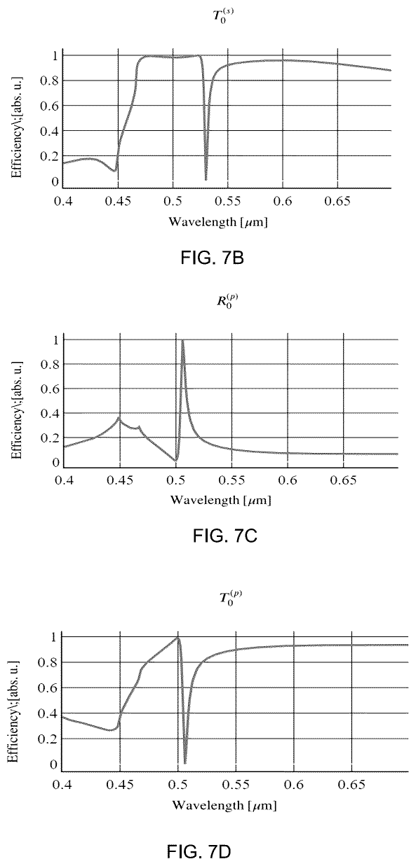

FIGS. 7A to 7D show, respectively, the reflectance of the s-polarized light

(FIG. 7A), the transmittance of the s-polarized light (FIG. 7B), the reflectance of

p-polarized light (FIG. 7C), and the transmittance of the p-polarized light (FIG. 7D). It is shown that with a single Metasurface structure of the present disclosure, the inventors achieve high-efficiency reflection at two wavelengths (450 nm and 530 nm) for

s-polarized light.

TABLE 3

| Layer | Material | Parameter | Value [μm] |
|---|---|---|---|
| Substrate | Fused silica (SiO₂) or | h_{sub} | >100 |
| | Corning ® EAGLE | | |
| | XG ® Glass | | |
| Support Layer | Nb₂O₅ | h_{lay} | 0.1485 |
| Grating | Nb₂O₅ | h_{g} | 0.1386 |
| Filling | Air | | |
| Overcoat | Fused silica (SiO₂) or | hₛᵤₚ + h_{oc} | >100 |
| Superstrate | Corning ® EAGLE | | |
| | XG ® Glass (same as | | |
| | substrate) | | |
| N/A | N/A | Λ | 0.1738 |
| N/A | N/A | w | 0.06 |

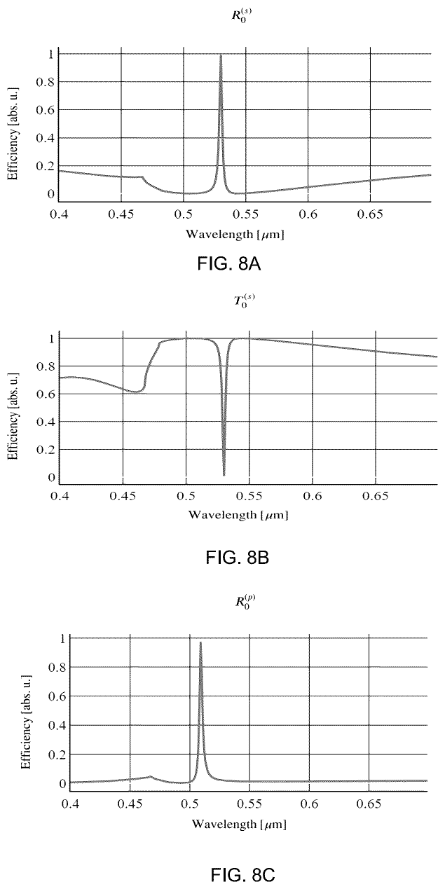

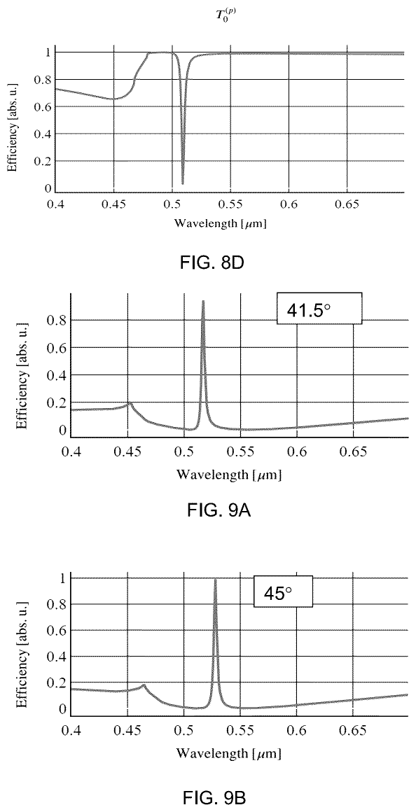

FIGS. 8A to 8D show, respectively, the reflectance of the s-polarized light

(FIG. 8A), the transmittance of the s-polarized light (FIG. 8B), the reflectance of p-polarized light (FIG. 8C), and the transmittance of the p-polarized light (FIG. 8D). The parameters used in the calculations are shown in Table 4. It can be seen that by decreasing the height of the grating ridge, h_{g}, by about a factor of 2, it is possible to change the resonance response of the Metasurface structure from two wavelengths (FIGS. 7A to 7D) to a single wavelength (FIGS. 8A to 8D).

TABLE 4

| Layer | Material | Parameter | Value [μm] |
|---|---|---|---|
| Substrate | Fused silica (SiO₂) or | h_{sub} | >100 |
| | Corning ® EAGLE | | |
| | XG ® Glass | | |
| Support Layer | Nb₂O₅ | h_{lay} | 0.13442605 |
| Grating | Nb₂O₅ | h_{g} | 0.05883321 |
| Filling | Air | | |
| Overcoat | Fused silica (SiO₂) or | hₛᵤₚ + h_{oc} | >100 |
| Superstrate | Corning ® EAGLE | | |
| | XG ® Glass (same as | | |
| | substrate) | | |
| N/A | N/A | Λ | 0.174 |
| N/A | N/A | w | 0.06 |

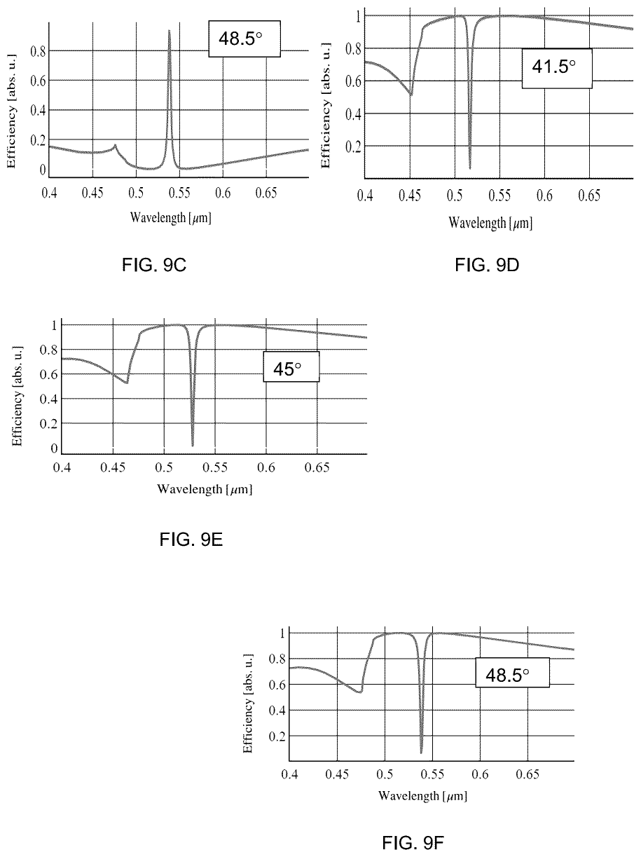

FIGS. 9A to 9F show results of calculation of reflection (FIGS. 9A to 9C) and transmission (FIGS. 9D to 9F) for s-polarization for, respectively, three different incidence angles: θᵢₙ=[41.5°, 45°, 48.5°] with structural and dimensional parameters shown in

Table 4. It is shown that the resonant wavelength of reflection depends on the incidence angle, which needs to be considered during optical combiner design.

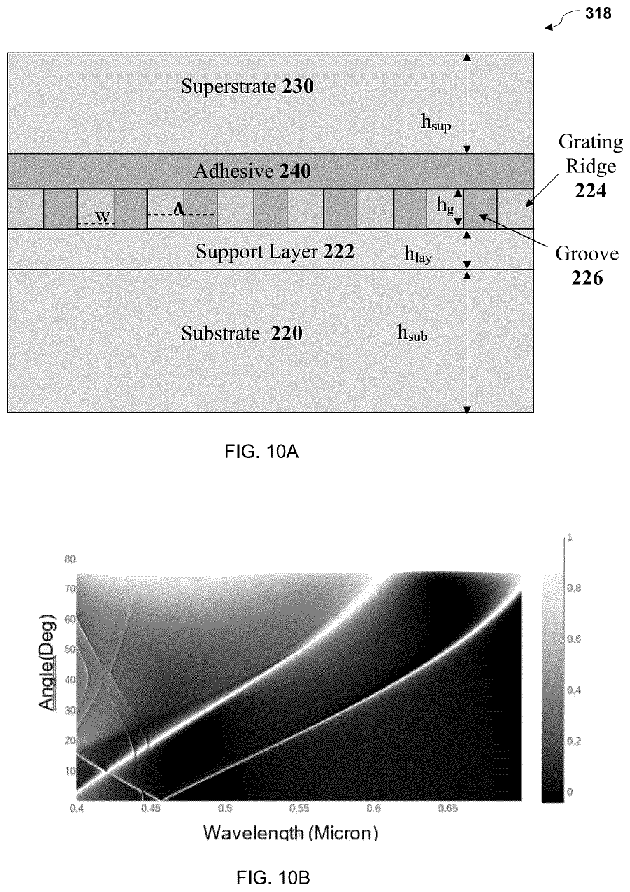

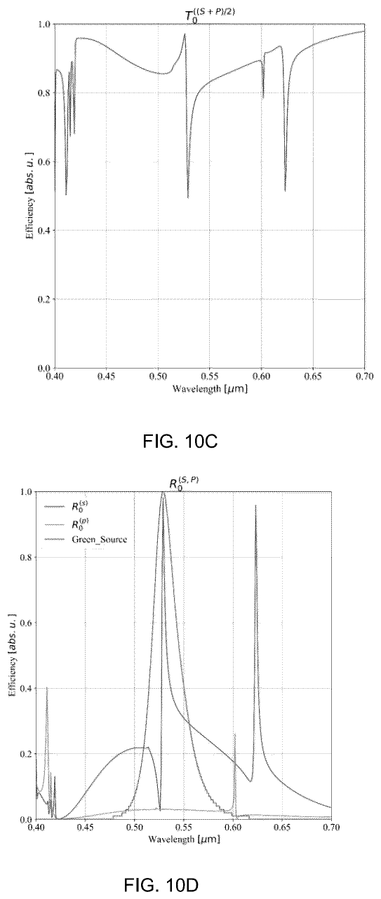

FIG. 10A shows a side view of an exemplary Metasurface structure 318 of the present disclosure having a pattern of a 1D grating with square ridges and grooves between them and configured to serve as a multi-wavelength selective band pass reflector. The Metasurface structure 318 is configured similar to the Metasurface 218 shown in

FIG. 4, except for the absence of the overcoat layer. Thus, the Metasurface structure 318 includes a substrate 220, a support layer 222, a patterned layer 223, adhesive layer 240, and a superstrate layer/plate 230.

In this specific but not limiting example, the substrate 220 and the superstrate 230 are made of glass, the material of the support layer 222 and grating ridges 224 is Nb₂O₅, and the grooves 226 are filled with optical adhesive that is index matched the glass.

In other embodiments, the substrate 220 and the superstrate 230 might be made of optical plastic resin, the material of the support layer 222 and grating ridges 224 is Nb₂O₅, and the grooves 226 are filled with optical adhesive that is index matched to the optical plastic resin.

FIG. 10B shows the calculated zero-order transmission of the Metasurface 318 demonstrating the existence of resonant reflection bands in a wide spectral range as a function of incidence angle. FIG. 10C shows the average transmittance efficiency for s- and p-polarizations and for an angle of incidence of 45°. FIG. 10D shows the reflectance efficiency at an angle of incidence of 45° for s- and p-polarizations and the emission spectrum of a green source. Thus, the inventors have shown that a single Metasurface can provide selective reflectance at Red (600-630 nm), Green (530 nm) and Blue (450-495 nm) wavelengths.

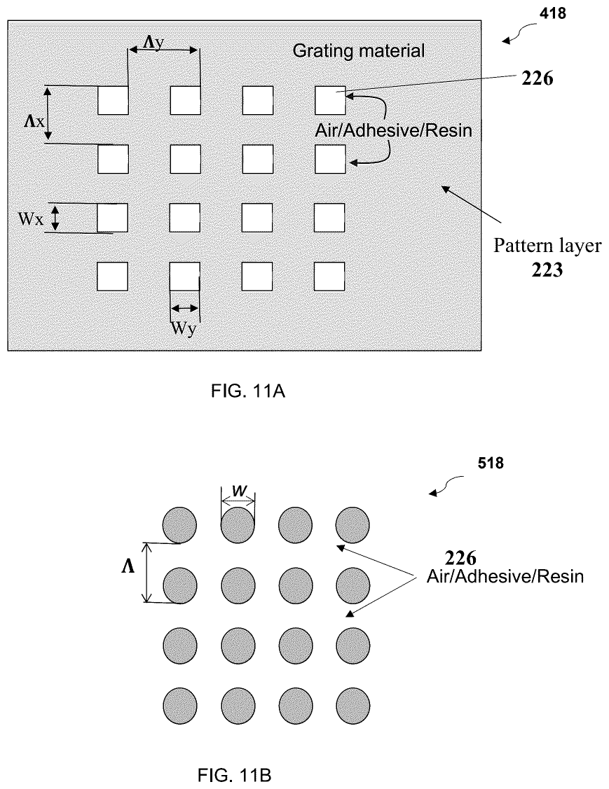

FIGS. 11A and 11B show top views of exemplary two-dimensional Metasurface structures 418 and 518, respectively, configured with a pattern of 2D square/rectangular grooves/holes 226 (FIG. 11A) and circular ridges/pillars (FIG. 11B) spaced by grooves between them. In FIG. 11A, the grooves/holes 226 are produced in a pattern layer 223 of high refractive index material otherwise being used to form grating ridges 224 (see, example FIG. 10A). In other words, the grooves/holes 226 of Metasurface structure 418 may be filled with air (in which case an overcoat needs to be used) or with a material having an index of refraction lower than the index of refraction of the pattern layer 223 (i.e. the layer in which the grooves/holes are produced), e.g., filled with optical adhesive/resin (in which case no overcoat is required). The 2D grating pattern of the Metasurface structure 418 is characterized by groove's widths wₓ and w_{y} and grating spatial periods Λx and Λy along the x and y axes, respectively. The 2D grating pattern of the Metasurface structure 518 is characterized by ridge/pillar's diameter w and grating spatial period Λ.

In other embodiments, the grating pattern of the Metasurface structure can assume other various shapes. The patterns may consist of pillars or holes (i.e., hollow cylinders), which can be filled/interpenetrated with a material like SiO₂ or another transparent substance (e.g., thermoset resin or optical adhesive), or alternatively, left empty. For the case of being left empty, an overcoat is required. The grating periods (Λx, Λy) are smaller than the light's wavelength to suppress diffractive orders.

The novel Metasurface-based partially transparent reflectors of the present disclosure were shown above to provide a near unity reflection efficiency at specific wavelengths and incidence angles (refer to FIGS. 5E, 6E, 6F, 7A, 7C, 8A, 8C, 9A-9C, 10C). However, Table 1 shows that actual mirror efficiencies may vary in the range of 10-25%. The efficiency breakdown of the Metasurface-based optical combiner of the present disclosure accounting for the major losses in the optical system are presented in Table 5 below.

TABLE 5

| Optical Losses | Cause of Loss |
|---|---|
| 22.5% | Light captured from the mLED into the lens |
| 70% | Total light reflected by the Metasurface-based combiner |
| 50% | About half of the light lands outside the 10 × 10 mm |
| | eyebox |

Total Light Efficiency: ~8%

Thus, the total light efficiency of the Metasurface-based optical combiner of the present disclosure is almost an order of magnitude higher than known in the art waveguide-based (geometric or diffractive) combiners. In the following, the inventors show that by considering the different incidence angles defined by the required field of view, the averaging over the wavelength spread of the source, and manufacturing errors, the maximum average reflection efficiency of a single partially-transparent reflector is about 25%.

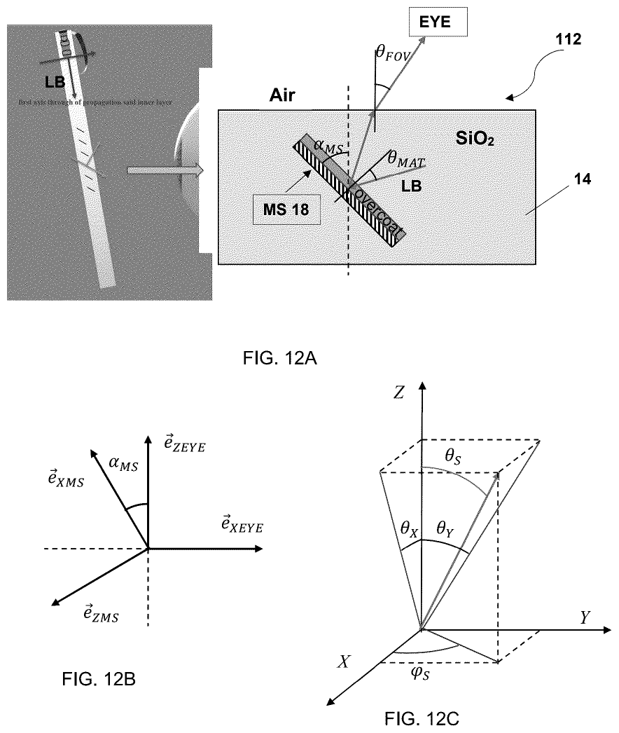

FIG. 12A shows schematically a unit 112 implemented as a glass (SiO₂) block with a single partially-transparent reflector 18 implemented as a Metasurface MS with a subwavelength grating (e.g., refer to the grating 218 of FIG. 4). In the following, the transformation of the direction of an incident light beam LB propagating within the glass block 14 by the reflector 18 is described. The reflector 18 has an overcoat (e.g., overcoat 228 of FIG. 4) and is embedded inside the glass block 14 with a tilt angle α_{MS} with respect to the outer surface of the glass block. The light beam LB propagating within the glass block from a projector, is incident with angle θ_{MAT} on the reflector 18, and undergoes reflection and refractions effects (due to the light passage through layers of different indices of refraction, i.e., light interacts with glass-overcoat interface and glass-air interface) within the Metasurface structure, and is output from the lens unit towards the user's eye. The direction of the incident wavevector within the glass medium is defined by angles inside the material and relative to the Metasurface cartesian coordinates. The direction of the output wavevector is defined by field of view (FOV) angles relative to the EYE frame.

FIG. 12B shows the relative orientation of the Metasurface MS and EYE frames. FIG. 12C defines the respective angles in the Metasurface MS and EYE frames. The direction of the outgoing beam relative to EYE frame is defined by FOV angles θ_{X}, θ_{Y}. The direction of the incident beam within the glass material relative to the Metasurface MS frame is defined by spherical angles θ_{S}, φ_{S}. These sets of angles can be transformed to each other by equations (1).

$$tan {θ}_{S} = \sqrt{{tan}^{2} {θ}_{X} + {tan}^{2} {θ}_{Y}} \\ tan {φ}_{S} = tan {θ}_{Y} / tan {θ}_{X} \\ tan {θ}_{X} = tan {θ}_{S} cos {φ}_{S} \\ tan {θ}_{Y} = tan {θ}_{S} sin {φ}_{S} \qquad ( 1 )$$

The components of the wavevector are given by:

$${k}_{X} = {k}_{0} sin {θ}_{S} cos {φ}_{S} \\ {k}_{Y} = {k}_{0} sin {θ}_{S} sin {φ}_{S} \\ {k}_{Z} = {k}_{0} cos {θ}_{S} \qquad ( 2 )$$

where k₀=2π/λ, λ is the wavelength.
The transform of the wavevector by refraction results in:

$${k}_{X 1} = {k}_{X 2} \\ {k}_{Y 1} = {k}_{Y 2} \\ {k}_{Z 2} = \pm \sqrt{{k}_{2}^{2} - {k}_{X 2}^{2} - {k}_{Y 2}^{2}} \\ {k}_{1} = 2 π {n}_{1} / {λ}_{0} \\ {k}_{2} = 2 π {n}_{2} / {λ}_{0} \qquad ( 3 )$$

where λ₀ is the wavelength in vacuum.
The transform of the wavevector by diffraction results in:

$${k}_{XDIFF} = {k}_{XINC} + 2 π m / d \\ {k}_{YDIFF} = {k}_{YINC} \\ {k}_{ZDIFF} = \pm \sqrt{{k}_{INC}^{2} - {k}_{XDIFF}^{2} - {k}_{YDIFF}^{2}} \qquad ( 4 )$$

where k_{INC}=2π/λ, m is the diffraction order.

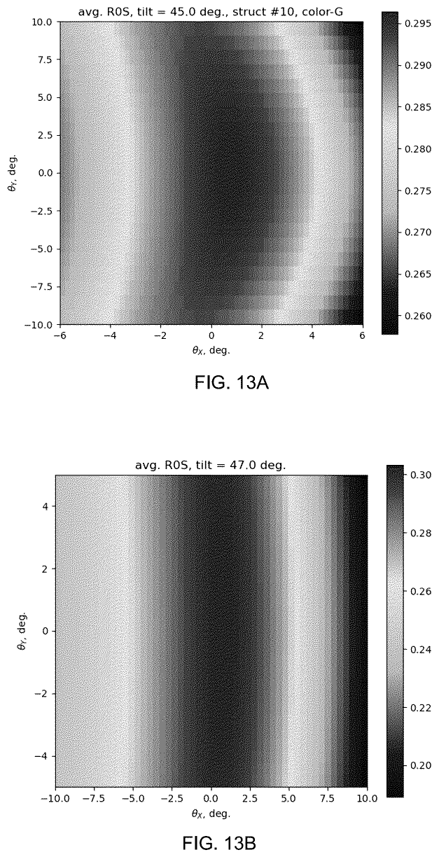

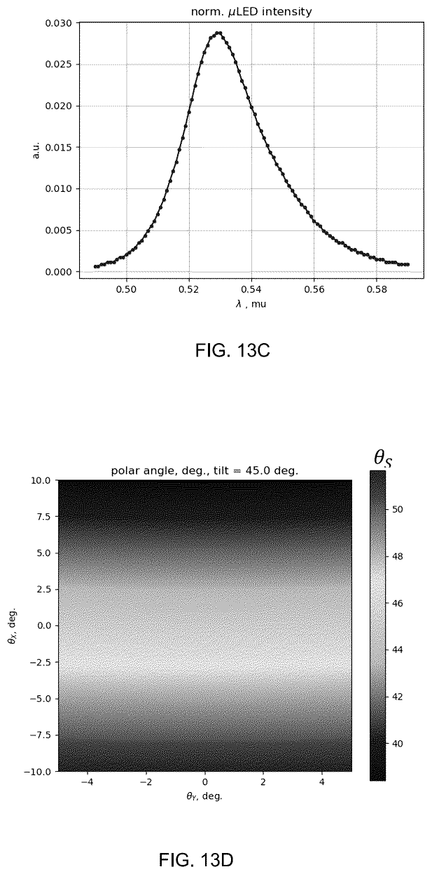

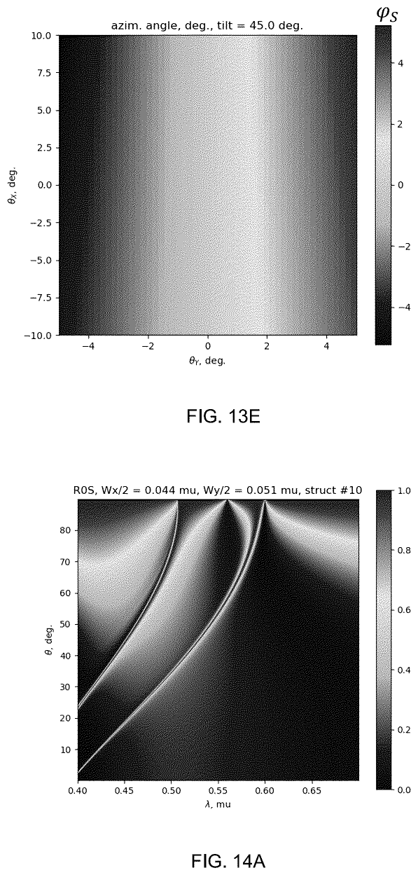

FIGS. 13A and 13B show the efficiency of the zero-order reflection (S-polarization) Ē_{ORS} (θ_{X}, θ_{Y}) as a function of FOV angles for a tilt angle α_{MS}=45° (FIG. 13A) and α_{MS}=47° (FIG. 13B). The efficiency is averaged over the spectrum of wavelengths emitted by a typical projector with normalized source intensity Iₙₒᵣₘ(λ):

$${\overline{E}}_{ORS} ( {θ}_{X} , {θ}_{Y} ) = {\int }_{λ 1}^{λ2} {E}_{ORS} ( {θ}_{X} , {θ}_{Y} , λ ) {I}_{norm} ( λ ) d λ$$

where λ₁=0.49 nm, λ₂=0.59 nm. FIG. 13C shows an example of a spectral density of a μLED source around the central Green (530 nm) emission wavelength, used in the efficiency calculations of FIGS. 13A and 13B.

FIGS. 13D and 13E show, respectively, the material spherical angles θ_{S} and φ_{S} as functions of FOV angles θ_{X}, θ_{Y}, for the wavelength λ=530 nm.

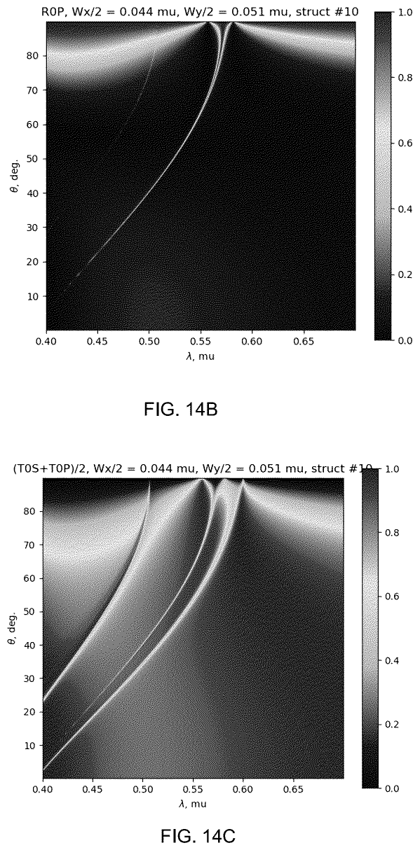

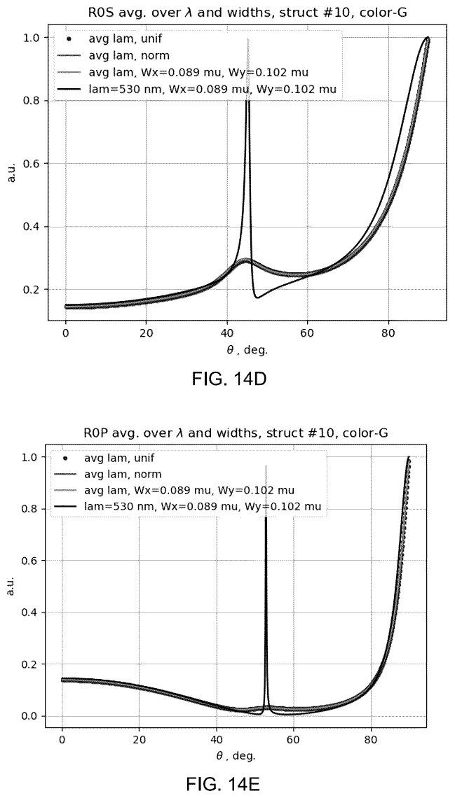

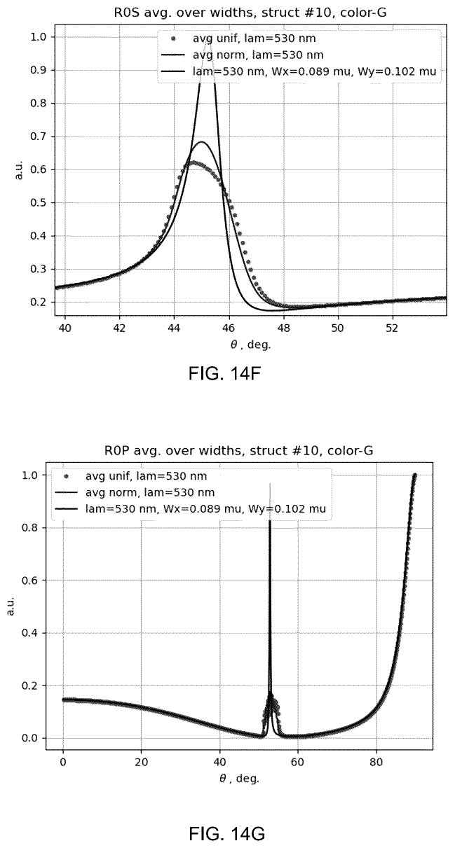

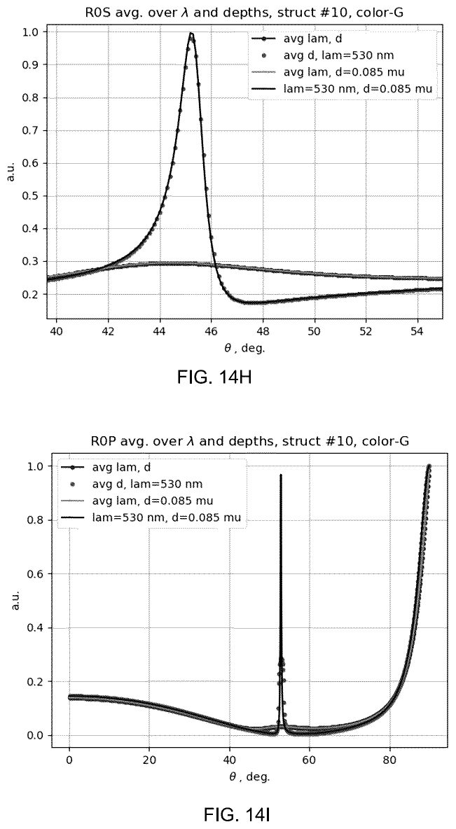

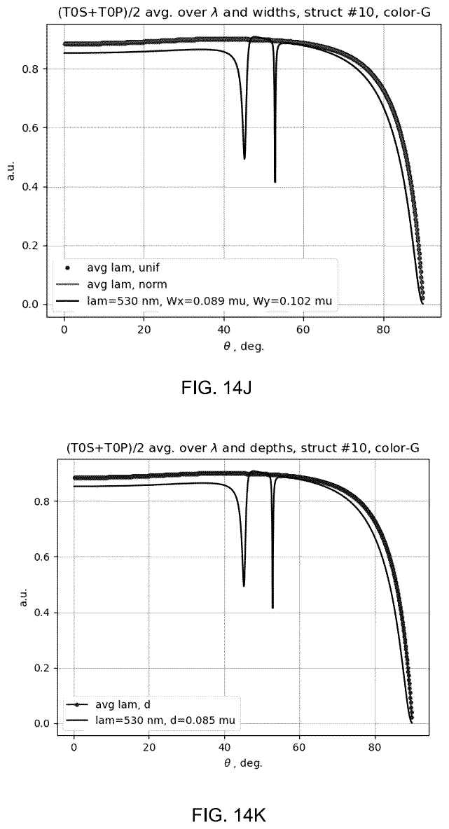

FIGS. 14A to 14K show calculation results of a two-dimensional Metasurface, e.g., resembling the Metasurface 418 of FIG. 11A using materials and dimensions as shown in Table 6 below and demonstrating the effects of averaging over various parameters, e.g., spectral density of source, ridge depth or width, on the reflection efficiency. FIGS. 14A and 14B show, respectively, the efficiency of the zeroth reflected order for s-polarization and p-polarization as a function of wavelength and polar incidence material angle (θ_{S} of FIG. 12C). The azimuthal incidence angle (φ_{S} of FIG. 12C) is 0 deg. FIG. 14C shows the average (over polarizations) transmitted efficiency of the zeroth order, (T0S+T0P)/2.

FIGS. 14D to 14K present several types of averaged reflection efficiencies. Full averaging is described by:

$${\overline{E}}_{Ran} ( θ ) = {\sum }_{k , m} {E}_{R α n} ( θ , {λ}_{m} , {w}_{k} ) {p}_{k} {I}_{norm} ( {λ}_{m} )$$

where the index α={S, P} depicts polarization, n=0 is the diffraction order. The function Iₙₒᵣₘ(λ) is the normalized spectral intensity of the source. The numbers {pₖ} are statistical weights of corresponding size, i.e., widths {wₖ} of the structure (diameter d of the circular post, or widths wₓ and w_{y} of rectangular posts) or its heights {hₖ}. The inventors consider also partial averaging, over wavelength λ or width w(d) only:

$${\overline{E}}_{R α n} ( θ , {w}_{0} ) = {\sum }_{m} {E}_{R α n} ( θ , {λ}_{m} , {w}_{0} ) {I}_{norm} ( {λ}_{m} ) , \\ {\overline{E}}_{R α n} ( θ , {λ}_{0} ) = {\sum }_{m} {E}_{R α n} ( θ , {λ}_{0} , {w}_{k} ) {p}_{k}$$

TABLE 6

| Layer | Material | Parameter | Value [μm] |
|---|---|---|---|
| Substrate | Fused silica (SiO₂) | h_{sub} | >100 |
| Support Layer | Nb₂O₅ | h_{lay} | 0.08588794 |
| Grating | Nb₂O₅ | h_{g} | 0.08546546 |
| Filling | Air | | |
| Overcoat | Fused silica (SiO₂) | hₛᵤₚ + h_{oc} | >100 |
| Superstrate | | | |
| | | Λx = Λy | 0.173 |
| N/A | N/A | wₓ | 0.089 |
| N/A | N/A | w_{y} | 0.102 |

FIGS. 14D and 14E show results of averaging over wavelength A and the widths {wₓ, w_{y}} for, respectively, s- and p-polarizations, demonstrating that averaging over wavelength A is enough to decrease the reflection efficiency from 1 (at) 45° to about 30% (FIG. 14D). The averaging over the widths is performed both for uniform (“unif”) and for normal (“norm”) distributions of widths' sizes.

FIGS. 14F and 14G show results of averaging over the widths {wₓ, w_{y}} (both uniform and normal distributions) for, respectively, s- and p-polarizations, and for a constant wavelength of 530 nm.

FIGS. 14H and 14I show results of averaging over wavelength A and the depth (height), h_{g}, of the grating ridges. It can be seen that reflection efficiency has a low sensitivity to the variability of the depth parameter alone and the major drop in efficiency results from averaging over the spectral distribution of the source.

FIGS. 14J and 14K show results of the average (over polarizations) transmitted efficiency of the zeroth order, (T0S+T0P)/2 where averaging is performed over wavelengths λ and widths {wₓ, w_{y}} (FIG. 14J) and over wavelengths λ and depths (FIG. 14K). The results confirm that the average transmittance of the Metasurface of the present disclosure is at least 95% in the vicinity of 45° incidence angle.

Periodic structures, e.g., diffraction gratings, may cause unwanted diffraction orders, leading to known artifacts in AR glasses such as rainbow and ghost effects. Another serious issue that annoys social interactions of AR users is the light leakage at out-coupler or eye glow effect, which refers to light out-coupled going outwards towards the environment from the optical combiner.

Regarding the rainbow effect, it is known that the larger the ratio of the wavelength to period (e.g., the grating period Λ in FIG. 4), the fewer diffraction orders will occur. The Metasurface structure of the present disclosure is used under off-axis illumination, with incidence angle of around 45 degrees. Therefore, the ratio of resonant wavelength/period is large and is roughly limited from the above by effective-RI*(1+sin (theta), where RI is refractive index and theta is ˜45 degrees. The subwavelength scale of the period of the Metasurface structures of the present disclosure allows for a larger wavelength-to-period ratio, thus reducing unwanted diffraction effects.

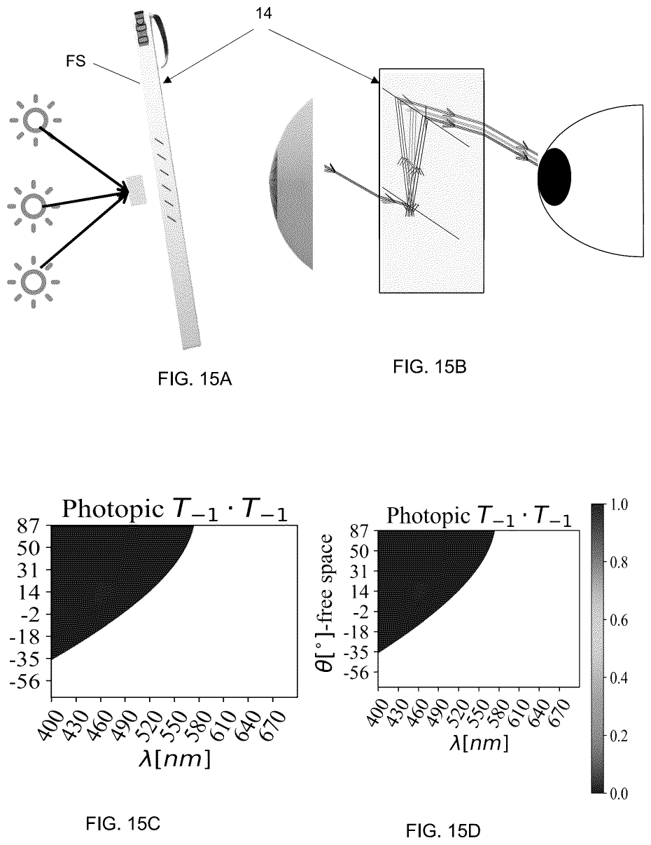

FIGS. 15A to 15D show the results of rainbow analysis of the Metasurface of the present disclosure from the front side (i.e. facing the environment). FIG. 15A schematically shows the rainbow effect on the front side FS of the lens 14. FIG. 15B shows Zemax simulation of the rainbow effect for free space angle of incidence (AOI) of ±80° and wavelengths λ=450 nm, 470 nm, and 490 nm (there is no diffraction with longer wavelengths). FIGS. 15C and 15D show the results of RCWA (Rigorous Coupled-Wave Analysis) simulation of two mirrors with combined 1st diffraction order. It should be noted that for light coming from the Sun and entering the front side of the glasses to pass through to the other side, it is to follow a path involving two mirrors, each directing the light at the first diffraction order. The inventors calculated the combined diffraction order efficiency and found it to be practically zero. Additionally, the result is to be multiplied by the photopic function, as light in these wavelengths will be barely visible to the human eye. FIG. 15C shows the transmitted light intensity (T₋₁·T₋₁) to the outside and FIG. 15D shows the respective total transmitted photopic intensity (T₋₁·T₋₁).

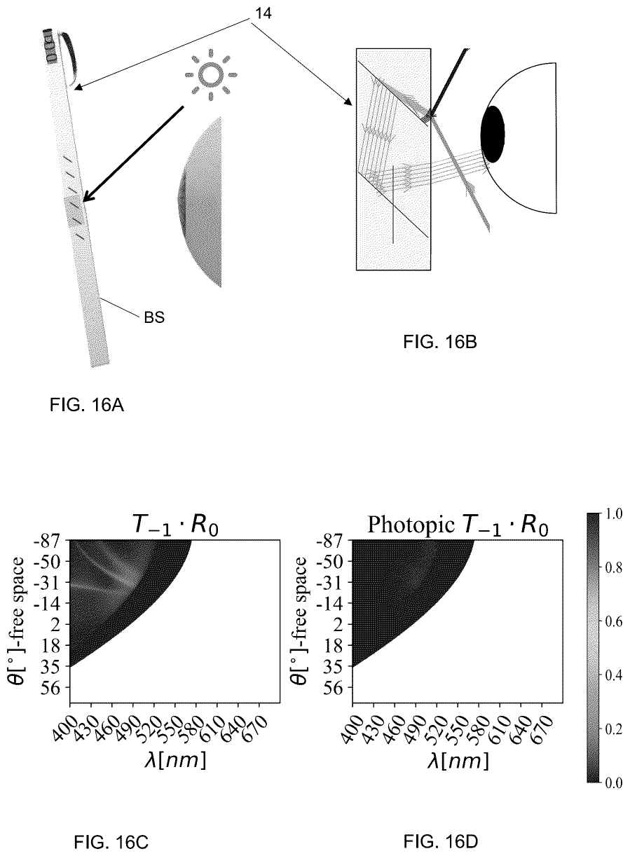

FIGS. 16A to 16D show the results of rainbow analysis of the Metasurface of the present disclosure from the back side (i.e. facing the user). FIG. 16A schematically shows the rainbow effect on the back side BS of the lens 14. FIG. 16B shows Zemax simulation of the rainbow effect for free space angle of incidence (AOI) of ±80° and λ=450 nm (there is no diffraction with longer wavelength). FIGS. 16C and 16D show the results of RCWA (Rigorous Coupled-Wave Analysis) simulation of two mirrors with combined 1^{st} diffraction order, wherein FIG. 16C shows the transmitted light intensity (T₋₁·R₀) towards the user's eye and FIG. 16D shows the respective total transmitted photopic intensity (T₋₁·R₀).

The results shown in FIGS. 15A to 15D and FIGS. 16A to 16D demonstrate that there is practically no rainbow (front and back) effect in the optical combiner based on Metasurface structures of the present disclosure.

As already mentioned above, one of the most significant artifacts encountered in waveguide-based optical combiners is the occurrence of eye glow, which refers to unintended leakage from the display that can be observed by other people in the vicinity of the user wearing the AR glasses. Eye glow may hinder eye contact between the user and others and may impact social interactions and communications.

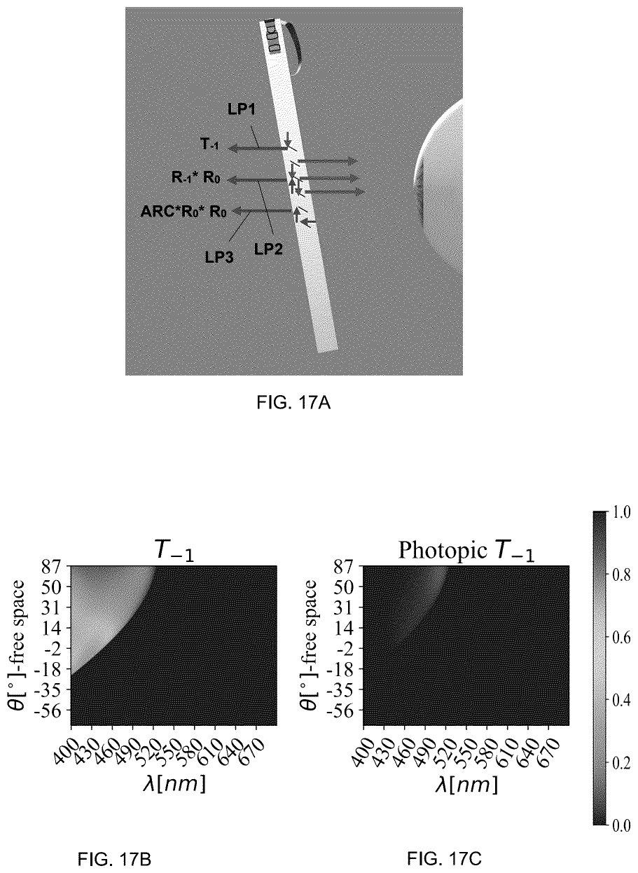

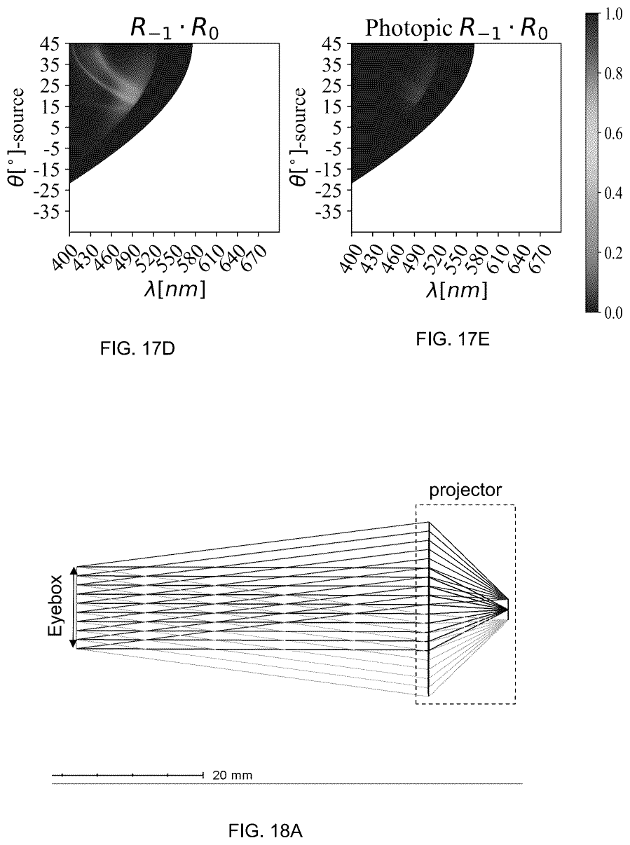

FIG. 17A illustrates three light paths, LP1, LP2, and LP3 that may be responsible for the occurrence of the eye glow. The first path, LP1, is caused by the T₋₁ transmission order of the partially-transparent reflector. The second path, LP2, is caused by two subsequent reflections of orders R₀ and R₋₁ from two neighboring partially-transparent reflectors. The third path, LP3, is caused by anti-reflection coating (ARC) of the lens and two subsequent zero-order reflections, R₀, from two neighboring partially-transparent reflectors.

FIGS. 17B to 17E show the distribution of light intensity due to eye glow for various light paths as a function of free space incidence angles for a typical visible wavelength range of a projector. FIGS. 17B and 17C show the calculation results of eye glow for the first path, LP1, wherein FIG. 17B shows the projector light intensity and

FIG. 17C shows the respective photopic light intensity. It can be seen that the eye glow in the first light path is smaller than 0.1%. FIGS. 17D and 17E show the calculation results of eye glow for the second path, LP2, wherein FIG. 17D shows the projector light intensity and FIG. 17E shows the respective photopic light intensity. The overlap integral of the light engine angles, spectrum is zero.

It should be noted that for Eyeglow to exist, the light path is to be such that the Metasurface directs light from the light engine outward through the first diffraction order. The light emitted by the light engine has a limited angular and wavelength spectrum, and the Metasurface's diffraction order also has its own wavelength and angular spectrum. Therefore, the Metasurface may not necessarily have diffraction efficiency at the light engine's specific wavelengths and angles. As a result, an overlap integral is calculated, showing that there is no diffraction efficiency for directing light outward at the light engine's angles and wavelengths. This is demonstrated using green light as an example. As for the third light path, LP3, assuming standard ophthalmic ARC, the Eyeglow intensity is of the order of 0.1% which corresponds to just a few nits (assuming 5,000 nits at the source).

As described above in detail, in the present disclosure the exit pupil of the projector is replicated along one dimension of the eyebox by successive reflections from the partially-transparent reflectors. In the axis that lacks exit pupil replication, the projector optics are required to have a large NA. However, projector optics that simultaneously accommodate a large pupil size and a wide field of view (in one axis) necessitate a high f-number, which can be challenging to design and often results in a bulky projector. In the following, the inventors provide a multi-screen approach offering a potential solution to address this issue and simplify the overall optical projector design.

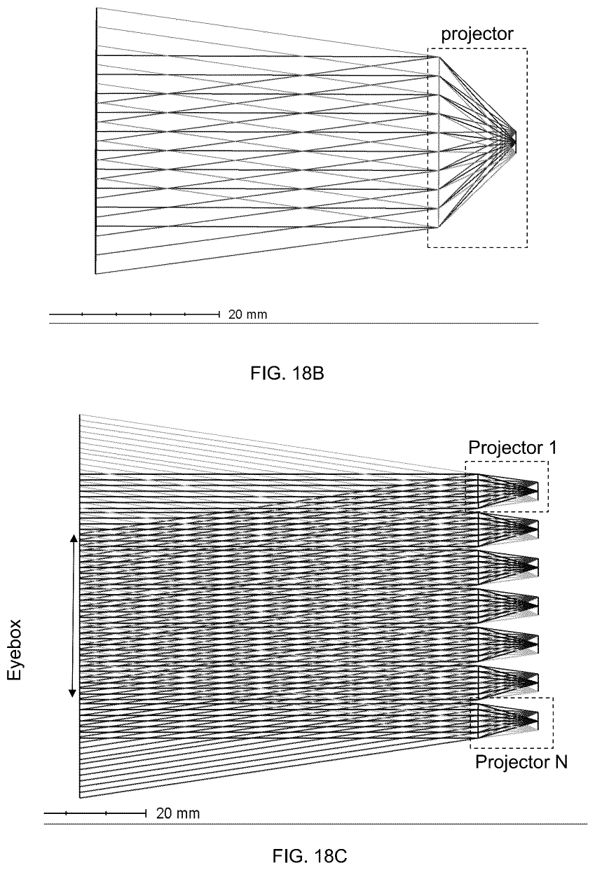

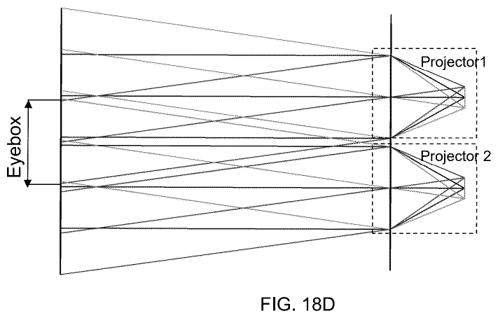

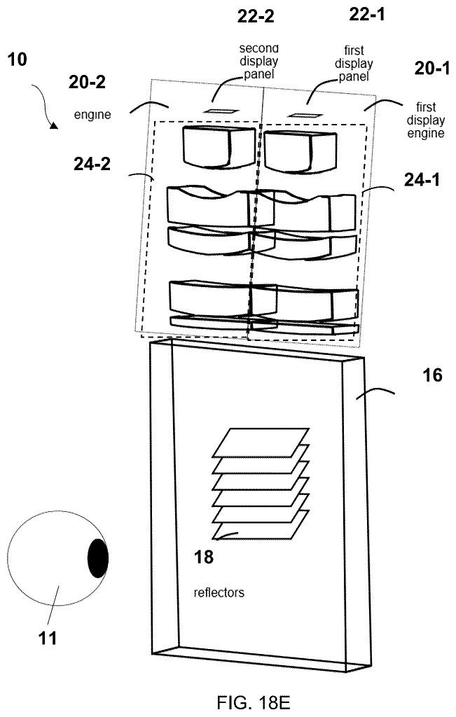

FIG. 18A shows a design of an ideal single projector and FIG. 18B shows a projector where energy loss results from a smaller projector f-number. FIG. 18C shows a design where N projectors (N≥1), each having a separate screen, are used. Many screens simplify the optical design dramatically. However, in this approach there is high energy loss due to the smaller f-number of each projector. FIGS. 18D and 18E show an optical system design based on two-projectors approach, wherein FIG. 18D shows the ray tracing defining the eyebox created by the two projectors and FIG. 18E shows schematically an optical system 10 including two projectors, 20-1 and 20-2, each including, respectively, display screens 22-1 and 22-2 and lens arrangements 24-1 and 24-2. Reducing the projector count to two results in a higher effective f-number, which leads to a moderate increase in projector size and/or complexity and no energy loss.

In the following, possible manufacturing methods of the lens unit of the present disclosure are described in detail. The methods described can be easily integrated with known in the art methods of ophthalmic lens manufacturing, e.g., based on UV curable or thermosetting molding techniques.

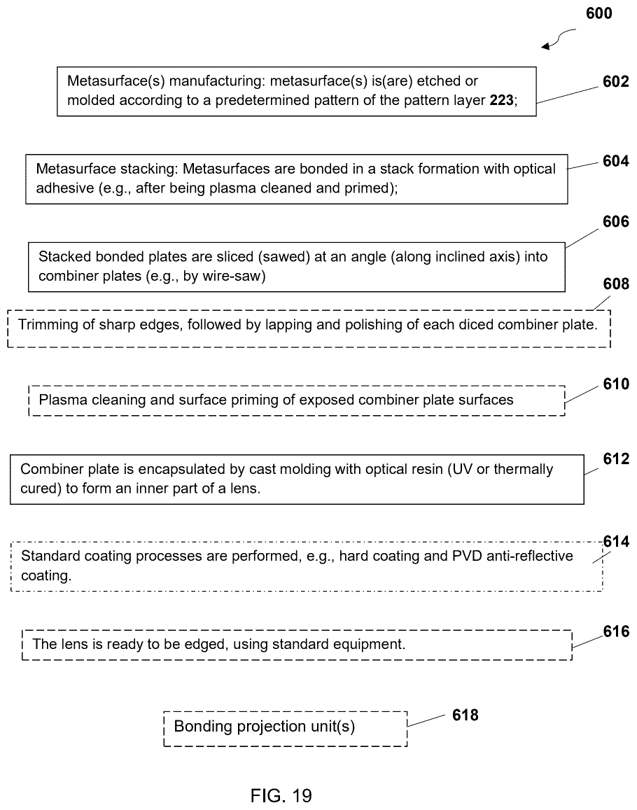

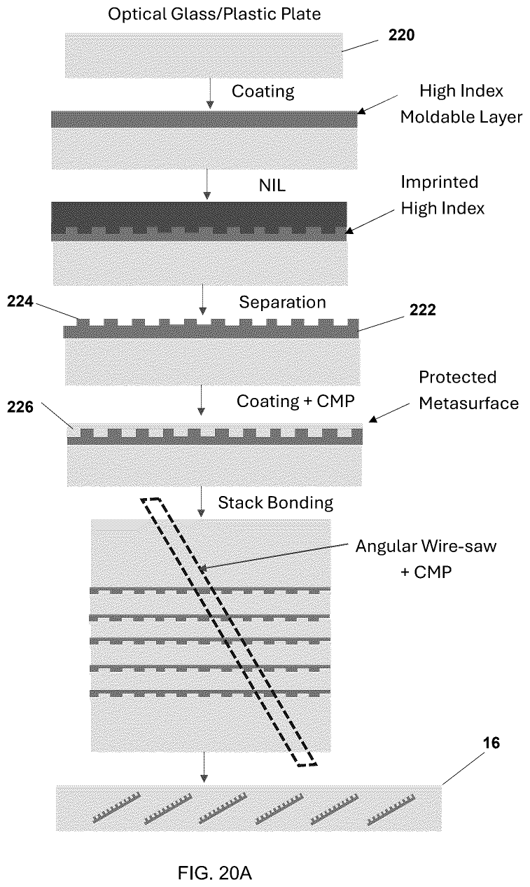

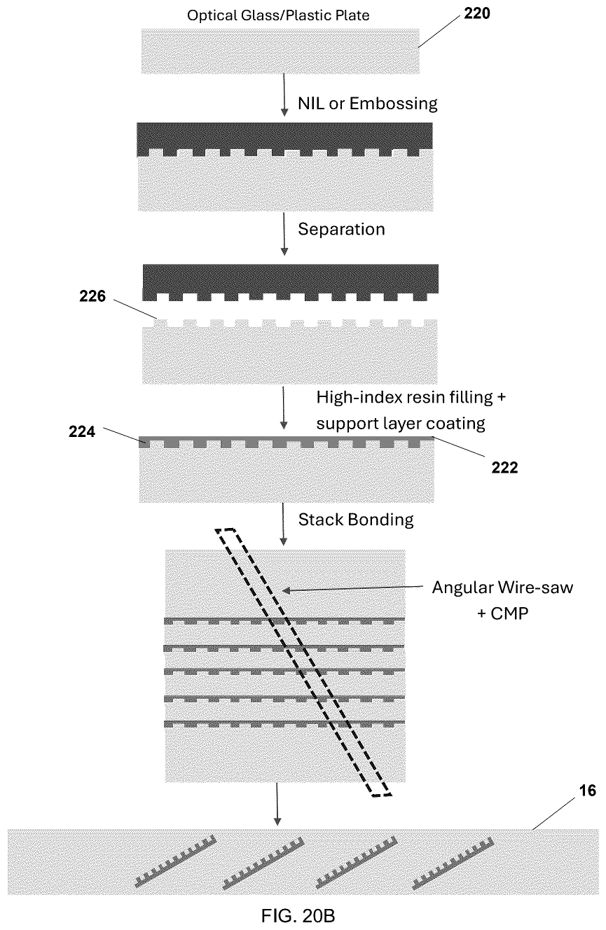

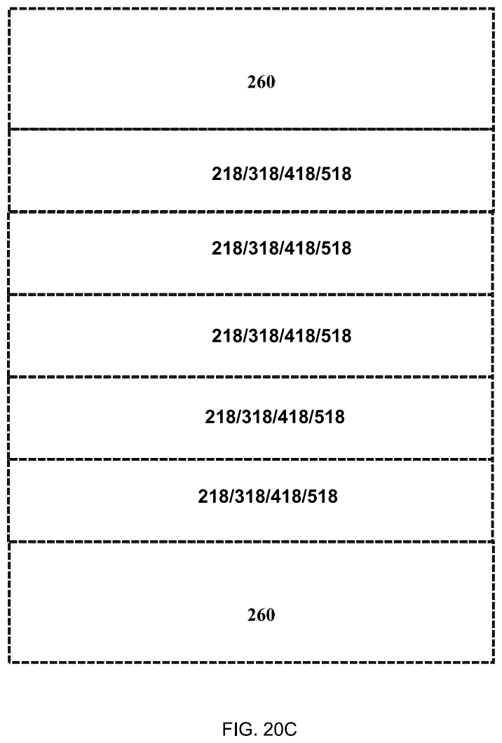

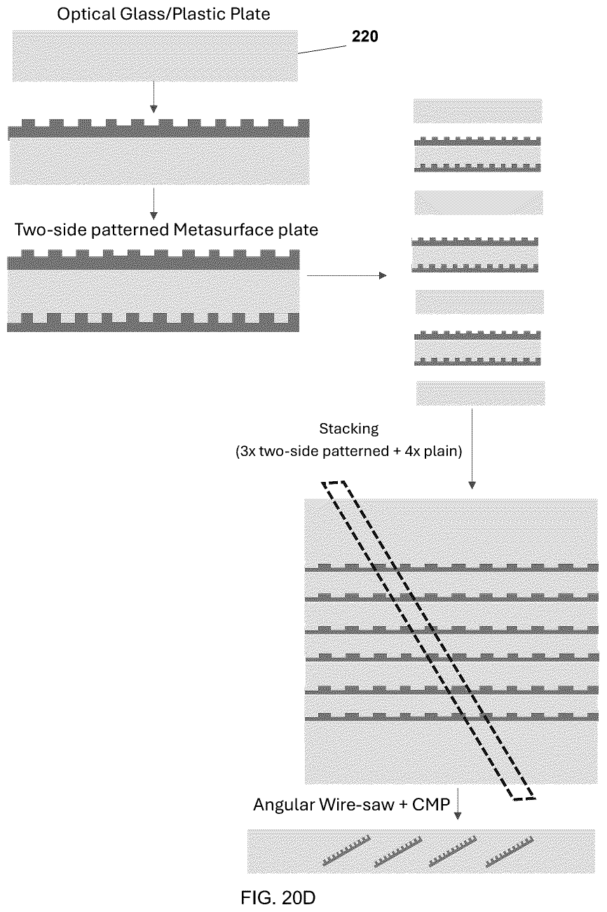

FIG. 19 shows a flow diagram 600 exemplifying a manufacturing method for manufacturing the lens unit of the present disclosure. FIGS. 20A to 20C and FIGS. 21A to 21D accompany the flow diagram of FIG. 19 and exemplify the various manufacturing steps in a self-explanatory manner.

First, wafer/plates are manufactured each carrying a Metasurface structure according to a predetermined grating pattern. The manufacturing method starts (step 602) with manufacturing a plurality of such wafers/plates (glass or plastic), each carrying a Metasurface structure according to a predetermined grating pattern(s).

FIGS. 20A and 20B describe two exemplary methods for manufacturing the Metasurface structures.

In the first example (FIG. 20A), an optical (glass or plastic) plate, serving as the substrate 220, is patterned by direct Nanoimprint Lithography (NIL) using high refractive index inorganic nanoparticle-based inks or high index permanent optical resists to directly form the Metasurface structure. Relevant nanoparticle ink or resists materials include, but not limited to, cubic zirconium oxide, titanium oxide (TiO₂), niobium pentoxide, aluminum oxide, diamond, hafnium oxide, tantalum oxide, or zinc oxide, fluorinated tin oxide, indium tin oxide, aluminum zinc oxide, indium zinc oxide, indium tin zirconium oxide, indium gallium oxide, indium gallium zinc oxide, tin oxide, or zinc oxide, or a relevant permanent commercially available optical high refractive index resists or adhesives.

A mold/template with a complementary pattern of a predetermined Metasurface structure (e.g., grating) is imprinted into this layer using the NIL process (press, fill, cure, separate), resulting in a predetermined pattern of ridges (e.g., 224 in FIG. 4) on top of a support layer (e.g., 222 in FIG. 4). In the next step, the Metasurface structure undergoes protecting coating with an optical coating that is index-matched to the index of the substrate 220 and chemical-mechanical polishing (CMP) aimed at preparing the Metasurface structure for bonding with other Metasurface structures in the next step. It should be noted that in this example, the grooves 226 between the ridges are filled with the (low-index) resin/adhesive, therefore, an overcoat layer is not required, and the protective coating thickness may be as small as 50-200 nm.

In some embodiments, the coating step of the Metasurface structure is optional, since during the following step (step 604) described below, the optical index-matched adhesive fills in the grooves 226, thus saving one manufacturing step.

In the second example (FIG. 20B) a predetermined Metasurface (e.g., grating) pattern is imprinted in a deposited optical permanent resist, that matches the substrate (glass or plastic) or embossed directly into the surface optical resin plate, serving as the substrate, resulting in a complementary Metasurface structure after separation of the template/mold. The complementary Metasurface features are filled with high-index coating and a support layer of predefined thickness is applied on top, forming thus the Metasurface structure in an “upside down” or a mirror-like process as compared to the method of FIG. 20A.

Referring now back to FIG. 19, the manufacturing method 600 continues with stacking a predetermined number of the Metasurface structure carrying plates (step 604), preferably after being plasma cleaned primed, and bonded using optical adhesive.

FIG. 20C exemplifies this step using five plates/wafers carrying Metasurface structures. Each one of the described above Metasurface structures, i.e., 218, 318, 418, or 518 can be used to form such a stack. The stack also includes bottom and top plates being glass plates 260. It should be noted that, in case additional spacing between adjacent Metasurface structures is required, glass or plastic spacers of predetermined thickness may be introduced during the bonding step 604.

The manufacturing process 600 is preferably also adapted for keeping the Metasurface structures carrying plates substantially parallel to one another during the stacking process. Such substantial parallelism condition provides a wedge angle under 20 arcsec between each two surfaces.

In yet another non-limiting option, the plates are stacked via a wafer bonding machine.

FIG. 20D shows yet another example of a manufacturing method including Metasurface stacking. In this method, two Metasurfaces are manufactured on respective two sides of the optical (glass or plastic) plate. On one side, the Metasurface can be manufactured using the method described above with reference to FIG. 20A, and on the other side, the Metasurface is manufactured using the method described above with reference to FIG. 20B. Then, empty glass or plastic optic plates (i.e., plates not containing Metasurfaces) are used as spacers between each pair of locally adjacent two-side patterned plates, to form the bonded stack.

This method advantageously provides the original parallelism of the optical plates and reduces the number of separate Metasurface-carrying plates that need to be bonded with the desired high parallelism condition. In other words, the parallelism between two neighboring Metasurfaces (of the same plate) is already fixed to the internal parallelism of the plate. Thus, referring to the example of FIG. 20D, instead of using N plates (6 plates) of Metasurfaces in the process exemplified in FIG. 20A or FIG. 20B, there are only N/2 plates (3 plates) with Metasurfaces to be stuck/bonded, reducing the number of degrees of freedom from N to N/2 (from 6 to 3).

Therefore, in this manufacturing method of FIG. 20D, the same material of the plate carrying the Metasurface structures can serve as the substrate 220 (of the top Metasurface structure) and superstrate 230 (of the lower Metasurface structure).

In step 606, the stacked bonded plates are sliced (sawed) along a cut axis, being inclined (forming an angle) with respect to the Metasurface plane, into combiner plates by a dicing saw or a single/multiwire-saw. Thus, a plurality of combiner plates 16

(see FIG. 1), each comprising a predetermined set of Metasurface plates defined during the bonding step 604, is obtained. The slicing is performed at a predetermined angle and is schematically shown in FIGS. 20A and 20B.

It should be noted that a multiwire sawing can be used as a slicing technique which uses a set of thin wires (e.g., down to about 18 μm thickness) and performs large scale simultaneous processing to obtain a desirably low slice thickness (e.g., about 100 μm). This technique helps to maintain similarity in cutting planes of the newly formed see-through combiner plates.

The slicing (sawing) might result in sharp edges of the combiner plates. Therefore, in step 608, sharp edges can be trimmed, followed by lapping and polishing (CMP) of each diced combiner plate to an optical surface level. Next (step 610), the combiner plates might undergo plasma cleaning and surface priming of exposed combiner plate surfaces.

It should be noted that some of the manufacturing steps, e.g., the wire-saw slicing and CMP steps 606 and 608, involve loss of material, e.g., the kerf thickness and polishing thickness removal, and, therefore, a concomitant change in dimensions. This should be taken into account during the manufacturing design steps, e.g., to design a distance between the cuttings.

The combiner plate 16 is now ready to be embedded/integrated inside the ophthalmic lens resin. In step 612, the combiner plate is encapsulated by cast molding with the lens material, e.g., optical resin (UV or thermally cured), to form the final lens unit, e.g., having a predetermined optical power profile.

The encapsulation may be performed using at least two different methods, shown schematically in FIGS. 21A to 21C: (1) encapsulation by gluing of the glass/plastic combiner plate between front and back lens segments (e.g., bonding to front and back plano-concave/convex lens segments), as shown in FIG. 21A; and (2) partial (FIG. 21B) or full (FIG. 21C) encapsulation by casting (e.g., optically clear UV-curable resin casting) or molding (e.g., optically clear liquid thermoset resin).

FIG. 21D exemplifies, in a self-explanatory manner, the method of partial encapsulation of a Metasurface strip/combiner inside a lens using a molding technique. A lens mold is manufactured according to a specific lens prescription, while considering the thickness of the glass/plastic combiner plate with embedded slanted Metasurfaces. The combiner plate is positioned inside the mold with specially designed fixtures guaranteeing precise positioning. The assembled mold is filled with the lens material, e.g., an optical plastic resin (either UV curable or thermosetting), partially encapsulating the combiner plate. Thereafter, the resin is hardened, the mold halves are split apart, and the lens is removed. In some embodiments, a curing step of the manufactured lens unit follows.

Referring back to the block diagram of FIG. 19, in step 614, standard (ophthalmic) coating processes may be added, e.g., hard coating and anti-reflective coating via PVD. In step 616, the lens is ready to be edged, using standard (ophthalmic) equipment.

As noted above, the optical system may also include projection unit(s) integral with the lens unit. Accordingly, as exemplified in FIG. 19, in the last step (step 618), one or more projection units may be bonded to the lens unit. In some embodiments, the projection unit(s) may be fully or partially bonded in a cavity created inside the lens unit.

FIG. 21E shows a flow diagram 650 including self-explanatory illustrations exemplifying yet another method for manufacturing the lens unit of the present disclosure including the lens with the embedded combiner (configured as described above). This method of FIG. 21E is based on manufacturing a plurality of segmented Metasurface structures on top of a plurality of plates made of a lens material (glass/plastic), stacking and bonding said plates, and slicing a relatively thick slice/plate (thicker plate than in the above-described method 600) from the stack resulting in a non-optical plate unit with embedded Metasurfaces (plurality of partially-transparent reflectors/Metasurface structures). This thick plate is then structured via CNC and polished to the final lens form.

Specifically, as shown in step 652, the glass/plastic plate (i-th plate) is formed with segmented Metasurfaces, i.e., an array of spaced-apart Metasurface structures (three such structures being shown in this non-limiting example), where each Metasurface structure is distanced from an adjacent Metasurface structure in the array by a predetermined distance, d. The first Metasurface structure on the i-th plate is placed at a predetermined distance, eᵢ, from the edge of the plate.

Each Metasurface structure may be manufactured by any suitable technique, e.g., by the method described in FIG. 20A or FIG. 20B.

A predetermined number of such plates with segmented Metasurfaces (four such plates being shown in the present non-limiting example) are prepared, stacked and bonded together (step 654).

In some embodiments, as illustrated in the figure, the plates are prepared such that the value of the distance between the first Metasurface structure and the edge of the plate varies in a predetermined order from plate to plate in the stack (e.g., distances e₁, e₂, e₃, e₄ are different from oner another in a predetermined manner). This provides a predetermined shift between the arrays of Metasurface structures of the multiple plates of the stack (shift with respect to an axis substantially perpendicular to the plate, i.e. to the Metasurface plane).

In some other embodiments (not shown), all the segmented Metasurface structures can be placed at a uniform predetermined distance, e, from the edge of the respective plate. In this case, during the stacking and bonding step 654, successive plates are displaced one with respect to the other to obtain the predetermined shift between the arrays of the Metasurface structures of the multiple plates. This embodiment provides for minimizing losses of lens material at the corners of the bonded stack due to inclined slicing.

Additionally, the stack also includes bottom and top plates 260 of predetermined thickness(es), defining the final height of the see-through combiner in the final lens.

In the next step (656) the stacked bonded plates are sliced (sawed) along a cut axis, being inclined (forming an angle) with respect to the Metasurface plane, into lens unit plates 12′ (by a dicing saw or a single/multiwire-saw), such that the thickness h of the resulting slice is thicker than the thickness of the final lens unit 12 to be used in the optical system.

Then (step 658) the sliced lens unit plate 12′ undergoes “shaping” treatment procedures, typically CNC shaping and optical polishing, to form the final lens unit 12, formed by a lens 14 (e.g., having a predetermined optical power profile) and including the combiner 16 embedded in the lens.

Thus, this method of FIG. 21E, while resulting in the combiner encapsulated in the lens, does not need/utilize the step of encapsulation of a combiner plate inside a lens as used in the above-described methods of FIGS. 21A-21C.

It should also be noted that in case the lens is to be formed with any tunable feature (e.g., tunable power, electrochromic, this can be easily realized by bonding an outside tunable feature on a flat lens 14, as shown in FIG. 21A.

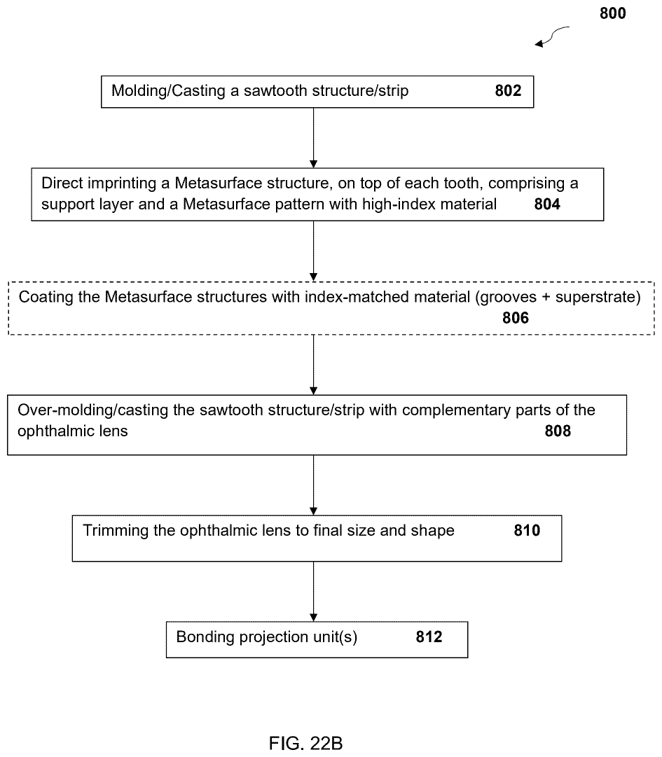

Reference is made to FIGS. 22A and 22B exemplifying, by way of flow diagrams 700 and 800, respectively, methods for manufacturing the lens unit of the present disclosure (e.g., comprising also the projection unit(s). Both methods include manufacturing of the Metasurface structures on a molded/casted sawtooth base structure, wherein each tooth of the sawtooth base structure carries an identical or different Metasurface structure, according to a predetermined design.

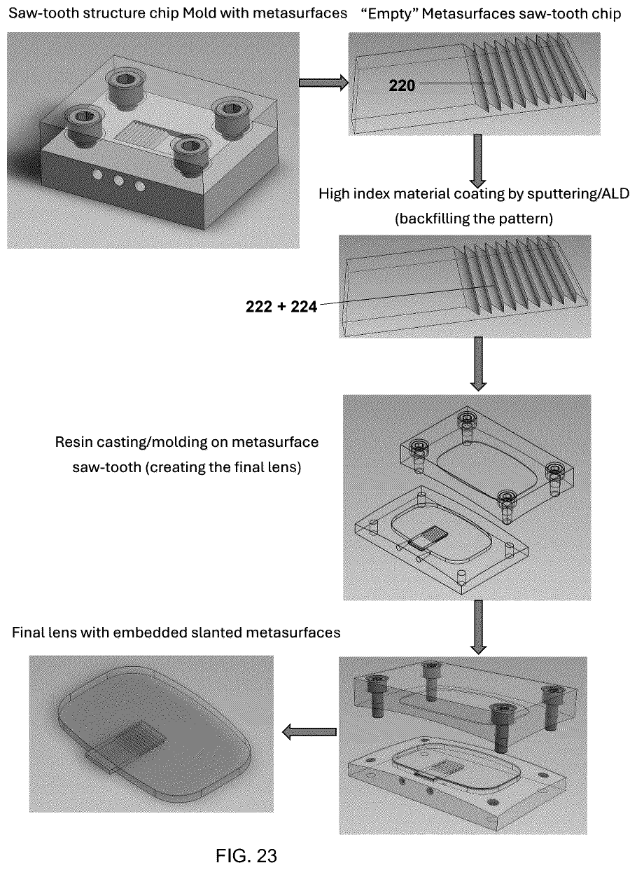

In the example of bock diagram 700 the method includes manufacturing of the Metasurface structures in an “upside down” fashion, resembling the method described with reference to FIG. 20B, and is described, in a self-explanatory manner also in FIG. 23. The first step (step 702) includes, in one step, molding/casting a sawtooth structure/strip and the respective Metasurface patterns (where each tooth surface serves as the superstrate 230 for the various Metasurface structures). This can be accomplished if the mold/template used for manufacturing the sawtooth structure chip contains already a mold/template with nanoscale features of the predetermined grating pattern designed to imprint the respective Metasurface structure on each tooth of the sawtooth structure, as shown in FIG. 23. Thus, step 702 results in a sawtooth chip with “empty” Metasurface structures, i.e., the nanoscale features on the surface are made out of the superstrate material and represent the grooves 226 to be filled with the ridge material of the grating pattern.

In the next step (step 704), the grooves are filled and coated with the high-index material (e.g., Nb₂O₅, high-index resin), forming thus the grating ridges 224, and the high-index support layer 222 of the Metasurface. In some embodiments, the manufacturer can employ a lithographic step to prevent deposition of the high index material on unwanted areas.

In the next step (step 706), the sawtooth structure/strip (carrying the Metasurface structures) is over molded/casted with complementary parts of the ophthalmic lens, as shown in FIG. 23. The lens is trimmed to final size and shape (step 708). Also, finally (step 710), the projection unit(s) may be bonded to the lens.

The method 800 shown in FIG. 22B, is different from method 700 in that the Metasurface structure manufacturing is performed “from bottom up”, i.e., first (step 802) the sawtooth structure/strip is formed from a UV curable or a thermoset resin. Then (step 804), a high-index material is used to directly imprint on top of each tooth a Metasurface structure including a support layer and a respective Metasurface pattern. In step 806, the Metasurfaces are coated with (low) index-matched material (corresponding to substrate refractive index), wherein the low-index material interpenetrates the grating ridges 224 created during the previous step. It is noted that step 806 is optional, since the following encapsulation of the sawtooth structure inside the lens fills the grating grooves with the low-index material (i.e., lens resin). Steps 808 to 812 are similar to steps 706 to 710 of method 700.

It should be noted that in both manufacturing methods 700 and 800 parallelism condition between the various partially-transparent reflectors (i.e. Metasurfaces) on the various teeth of the sawtooth plate is preferably provided. This may be achieved based on the original mold that is used for casting the saw-tooth.

In some embodiments, the manufacturing methods 700 and 800 may include bonding two sawtooth structures that are generated separately.

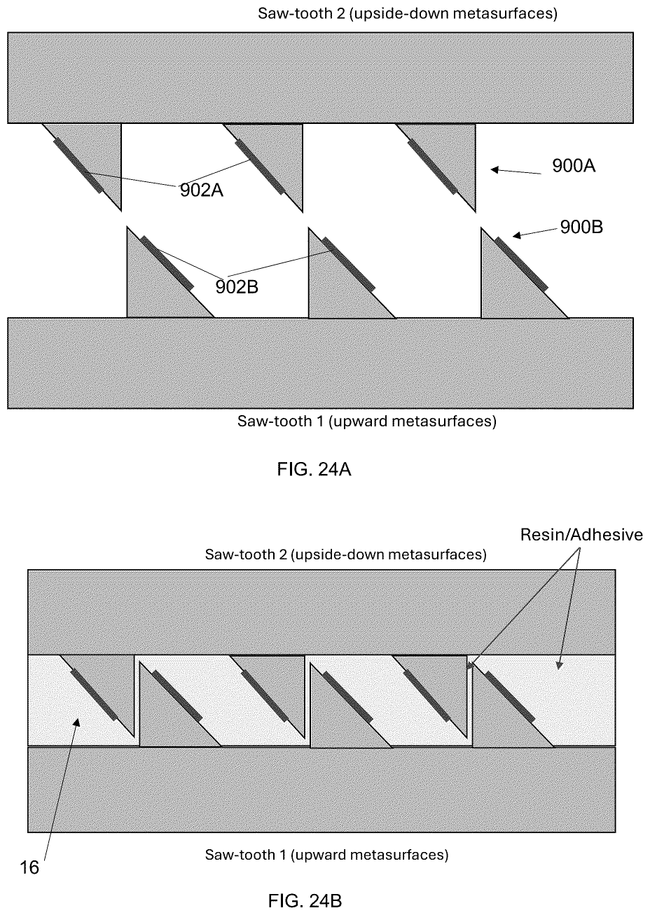

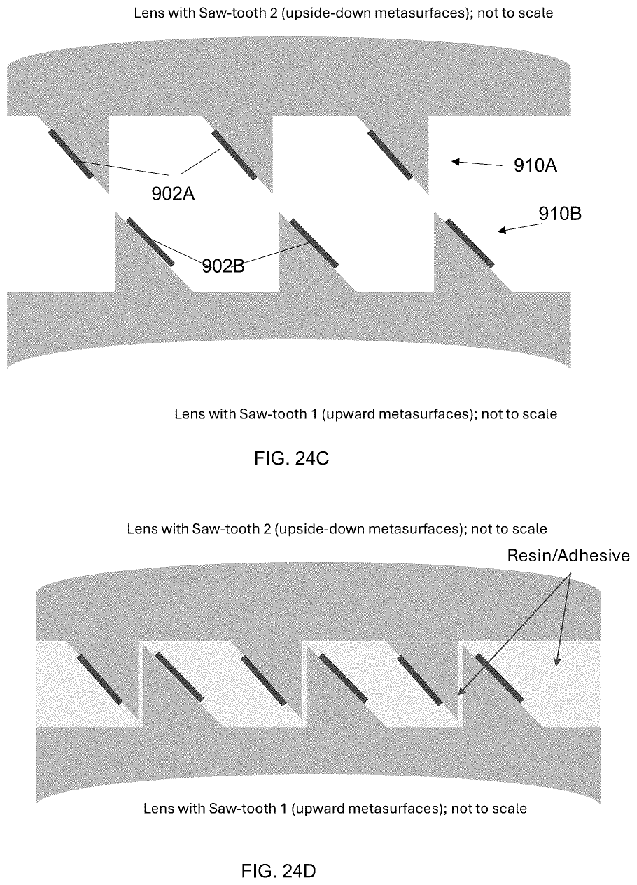

Reference is made to FIGS. 24A to 24D describing manufacturing methods of the see-through optical combiner of the present disclosure (FIGS. 24A-24B) and lens unit of the present disclosure (FIGS. 24C-24D), based on interlacing a pair of saw-tooth structures.

FIG. 24A shows two matching saw-tooth structures 900A and 900B made of a suitable optically transparent material of the combiner body (of a predetermined refractive index, e.g., that of substrate 220 in FIG. 4), where each tooth carries the respective/relevant partially-transparent reflector structure (Metasurface structure), and in the right orientation. More specifically, the teeth of the saw-tooth structure 900A with their Metasurface structures 902A are configured and oriented in an interlacing fashion with proper alignment with the teeth with Metasurface structures 902B of the saw-tooth structure 900B. This provides that when the matching saw-tooth structures 900A and 900B are bonded to one another, an array/arrangement of the Metasurface structures (reflectors) of the combiner is provided. FIG. 24B shows interlacing and bonding of the two saw-tooth structures by filling vacant cavities with the relevant index-matched adhesive/resin.

This results in a combiner plate 16 with smooth surfaces on both sides and thereby may facilitate the precise integration of the combiner plate inside the lens.

It should be noted that one can use CNC and optical polishing to form an optical lens with predetermined power. It should also be noted that in case the lens is to include tunable optical features, e.g., tunable lens, this can be implemented by attaching these on the external surfaces, as depicted in FIG. 21A.

FIGS. 24C and 24D exemplify how the principles of the above-described technique of FIGS. 24A-24B can be used for direct manufacture of the lens unit.

FIGS. 24C-24D that, similarly to FIGS. 24A-24B, molded matching saw-tooth structures 910A and 910B are provided being configured generally similar to the structures 900A and 900B (i.e., each tooth is formed with a predetermined partially-transparent reflector/Metasurface structure) but the saw-tooth plates are made of a lens material and the back-sides are already shaped to final respective lens form.

It should also be noted that, as described above, the reflectance efficiencies of the partially transparent reflectors in the combiner may be different, e.g., gradually increasing from the first to the last reflector in a direction of the light propagation through the combiner, to thereby provide a uniformly illuminated eyebox. This is taken into account when determining and creating the grating patterns of the Metasurface structures of the reflectors being manufactured.

1. An optical system for use in augmented reality glasses, the optical system defining an eyebox and comprising a lens unit comprising: an integral structure formed by a lens having a predetermined wavefront curvature, and a see-through optical combiner embedded inside the lens such that said see-through optical combiner is located in an inner part of the lens being enclosed by opposite lens segments of, respectively, front and rear parts of the lens, said see-through optical combiner comprising a plurality of partially-transparent reflectors arranged in a spaced-apart parallel relationship along said inner part and exposed to interaction with input light propagating along a first axis through said inner part of the lens and being indicative of image being projected with a certain exit pupil, said partially-transparent reflectors being inclined with respect to said first axis, such that said partially-transparent reflectors successively interact with the input light, and form light reflections therefrom, thereby providing replication of said exit pupil along a first dimension of the eyebox while maintaining said wavefront curvature of the lens.

2. The optical system according to claim 1, wherein said partially-transparent reflectors have different reflectance efficiencies.

3. The optical system according to claim 2, wherein said partially-transparent reflectors are configured with gradually increasing reflectance efficiencies from a first to a last partially-transparent reflector in a direction of the input light propagation along the first axis, to thereby provide uniform illumination of the eyebox.

4. The optical system according to claim 1, wherein each of said partially-transparent reflectors is configured such that a partial reflectivity of said partially-transparent reflector is wavelength and angle of incidence dependent, thereby partially reflecting light of predetermined wavelengths at predetermined angles towards user's eye.

5. The optical system according to claim 1, wherein said partially-transparent reflector is characterized by at least one of the following:
is configured to partially reflect a number N (N≥1) of predetermined discrete wavelengths;
has a reflectance efficiency of 10%-25% in a wavelength range of the input light indicative of the image being projected;
is configured with a one-dimensional or two-dimensional grating pattern.

6. The optical system according to claim 1, wherein said partially-transparent reflector comprises a Metasurface structure being a multi-layer structure comprising an intermediate patterned layer having a one-dimensional or two-dimensional grating pattern, said Metasurface structure being adapted to partially reflect a number N (N≥1) of predetermined discrete wavelengths.

7. The optical system according to claim 6, wherein said one-dimensional or two-dimensional grating pattern is arbitrary and/or non-periodic.

8. The optical system according to claim 1, wherein said inner part has a thickness of about 0.5-4 mm.

9. The optical system according to claim 6, wherein said Metasurface structure comprises:
a first layer being a substrate of a predetermined first thickness and a first index of refraction,
a second layer interfacing with the first layer, said second layer being configured as a support layer of a predetermined second thickness and a second index of refraction being higher than the first index of refraction,
a third layer interfacing with the second layer, said third layer being said patterned layer comprising a pattern formed by ridges and grooves of said one-dimensional or two-dimensional grating pattern, wherein said ridges have a third index of refraction higher than said first index of refraction, and said grooves are filled with air, and
a fourth layer interfacing with the third layer, said fourth layer being an overcoat layer of a predetermined fourth thickness and a fourth index of refraction being lower than said second index of refraction.

10. The optical system according to claim 9, wherein said Metasurface structure further comprises a fifth layer interfacing with said fourth layer and being a superstrate layer of a predetermined fifth thickness and fifth index of refraction being lower than the second index of refraction.

11. The optical system according to claim 6, wherein said partially transparent Metasurface comprises:
a first layer being a substrate of a predetermined first thickness and a first index of refraction,
a second layer interfacing with the first layer, said second layer being configured as a support layer of a predetermined second thickness and a second index of refraction being higher than the first index of refraction,
a third layer interfacing with the second layer, said third layer being said patterned layer comprising a pattern formed by ridges and grooves of said one-dimensional or two-dimensional grating pattern, wherein said ridges have said second index of refraction, and said grooves are filled with a material having an index of refraction lower than said second index of refraction.

12. The optical system according to claim 11, wherein said Metasurface structure further comprises a superstrate layer interfacing with said third layer and having a predetermined thickness and index of refraction lower than the second index of refraction.

13. The optical system according to claim 1, wherein said lens unit comprises said opposite lens segments configured as matching bonded saw-tooth structures, respectively, such that teeth of the saw-tooth structures of the opposite lens segments are arranged in an interlaced fashion, and wherein each tooth of the saw-tooth structures carries a respective one of the partially-transparent reflectors.

14. The optical system according to claim 1, further comprising at least one projector configured and operable to propagate said input light directly along said first axis to be successively incident at an oblique angle on said partially-transparent reflectors.

15. The optical system according to claim 14, characterized by at least one of the following:
the at least one projector comprises a micro display comprising any one of the following: OLED, Micro-OLED, LCD, MicroLED, laser scanner, or DLP;
the at least one projector is either embedded inside the lens, or located outside the lens;
the at least one projector comprises a lens assembly configured to define said exit pupil, such that the exit pupil has an elongated geometry with a large aspect ratio between said first dimension and a second dimension of the exit pupil, wherein said first dimension is replicated by the combiner and said second dimension defines a second dimension of the eyebox.

16. The optical system according to claim 14, wherein the at least one projector comprises a lens assembly configured to define said exit pupil, such that the exit pupil has an elongated geometry with a large aspect ratio between said first dimension and a second dimension of the exit pupil, wherein said first dimension is replicated by the combiner and said second dimension defines a second dimension of the eyebox, said second dimension of the eyebox being defined by one of the following (i) is defined by the second dimension of the lens assembly of the single projector; or (ii) is defined by second dimensions of lens assemblies of two or more projectors.

17. The optical system according to claim 1, wherein said lens segments are characterized by at least one of the following:
the lens segments are made of material compositions different from those of the inner part containing the combiner;
the lens segments are made of one or more plastic materials, and said inner part is configured as a glass or plastic body with said partially-transparent reflectors embedded inside said glass or plastic body.

18. Augmented reality glasses comprising: a pair of optical systems associated with a pair of lenses of the glasses, wherein each of the optical systems is configured according to claim 1.

19. The augmented reality glasses according to claim 18, wherein each of said optical systems comprises at least one projector configured and operable to propagate the input light directly along said first axis to be successively incident at an oblique angle on said partially-transparent reflectors.

20. The augmented reality glasses according to claim 19, characterized by at least one of the following:
the at least one projector is embedded inside the respective lens or is located outside the respective lens;
the at least one projector comprises a lens assembly configured to define said exit pupil of the respective optical system, such that the exit pupil has an elongated geometry with a large aspect ratio between said first dimension and a second dimension of the exit pupil, wherein said first dimension is replicated by the combiner and said second dimension defines a second dimension of the eyebox.

21. The augmented reality glasses according to claim 19, wherein the at least one projector comprises a lens assembly configured to define said exit pupil of the respective optical system, such that the exit pupil has an elongated geometry with a large aspect ratio between said first dimension and a second dimension of the exit pupil, wherein said first dimension is replicated by the combiner and said second dimension defines a second dimension of the eyebox, wherein said second dimension of the eyebox is defined by one of the following: (i) is defined by the second dimension of the lens assembly of the single projector; or (ii) is defined by second dimensions of lens assemblies of two or more projectors.

22. The augmented reality glasses according to claim 18, wherein:
each of the optical systems is associated with a pair of projectors configured and operable to propagate the input light directly along said first axis to be successively incident at an oblique angle on said partially-transparent reflectors, the projectors comprising lens assemblies configured to define together said exit pupil of the respective optical system, such that the exit pupil has an elongated geometry with a large aspect ratio between said first dimension and a second dimension of the exit pupil, wherein said first dimension is replicated by the combiner and said second dimension defines a second dimension of the eyebox.

23. The augmented reality glasses of claim 22, wherein the projectors are located in any one of the following regions: temple mount, nose bridge, eyebrow bridge.

24. A see-through optical combiner for use in an optical system comprising a glass or plastic body and a plurality of partially-transparent reflectors arranged in a spaced-apart parallel relationship along said glass or plastic body there inside to successively interact with an input light propagating in a direction through said body, wherein each of said partially-transparent reflectors comprises a Metasurface structure having a grating pattern and being adapted to partially reflect a number N (N≥1) of predetermined discrete wavelengths.

25. The see-through optical combiner according to claim 24, wherein said Metasurface structure is a multi-layer structure comprising an intermediate patterned layer having a one-dimensional or two-dimensional grating pattern, said Metasurface structure being adapted to partially reflect a number N (N≥1) of predetermined discrete wavelengths.

26. The see-through optical combiner according to claim 25, wherein said one-dimensional or two-dimensional grating pattern is arbitrary and/or non-periodic.

27. The see-through optical combiner according to claim 24, wherein said Metasurface structure comprises:
a first layer being a substrate of a predetermined first thickness and a first index of refraction,
a second layer interfacing with the first layer, said second layer being configured as a support layer of a predetermined second thickness and a second index of refraction being higher than the first index of refraction,
a third layer interfacing with the second layer, said third layer being said patterned layer comprising a pattern formed by ridges and grooves of said one-dimensional or two-dimensional grating pattern, wherein said ridges have a third index of refraction higher than said first index of refraction, and said grooves are filled with air, and
a fourth layer interfacing with the third layer, said fourth layer being an overcoat layer of a predetermined fourth thickness and a fourth index of refraction being lower than said second index of refraction.

28. The see-through optical combiner according to claim 27, wherein said Metasurface structure further comprises a fifth layer interfacing with said fourth layer and being a superstrate layer of a predetermined fifth thickness and fifth index of refraction being lower than the second index of refraction.

29. The see-through optical combiner according to claim 25, wherein said partially transparent Metasurface comprises:
a first layer being a substrate of a predetermined first thickness and a first index of refraction,
a second layer interfacing with the first layer, said second layer being configured as a support layer of a predetermined second thickness and a second index of refraction being higher than the first index of refraction,
a third layer interfacing with the second layer, said third layer being said patterned layer comprising a pattern formed by ridges and grooves of said one-dimensional or two-dimensional grating pattern, wherein said ridges have said second index of refraction, and said grooves are filled with a material having an index of refraction lower than said second index of refraction.

30. The see-through optical combiner according to claim 29, wherein said Metasurface structure further comprises a superstrate layer interfacing with said third layer and having a predetermined thickness and index of refraction lower than the second index of refraction.

31. The see-through optical combiner according to claim 24, being manufactured by a method comprising:
manufacturing a plurality of glass or plastic plates, each carrying the Metasurface structure;
stacking the plurality of said plates and bonding them together using an optical adhesive, to form a bonded stack;
slicing said bonded stack along a cut axis inclined at a predetermined angle with respect to a Metasurface plane, into a plurality of combiner plates, each comprising a predetermined set of Metasurface structures.

32. The see-through optical combiner according to claim 31, comprising applying a liquid or vapor surface chemical priming to each of said Metasurface structures prior to said stacking.

33. The see-through optical combiner according to claim 24, being manufactured by a method comprising:
manufacturing, by a single molding or casting step, a sawtooth structure, in which each tooth carries a respective Metasurface structure of a predetermined grating pattern, wherein a material composition used for the molding or casting step has a first index of refraction;
interpenetrating features of the grating pattern of the Metasurface structures with a material composition having a second index of refraction being higher than the first index of refraction;
applying a support layer having the second index of refraction on top of the Metasurface structures.

34. The see-through optical combiner according to claim 24, being manufactured by a method comprising:
manufacturing, by molding or casting, a sawtooth structure using a material composition having a first index of refraction;
manufacturing, on top of each tooth of the sawtooth structure, a Metasurface structure comprising a support layer and a respective grating pattern of features, using a material having a second index of refraction being higher than the first index of refraction;
interpenetrating feature of the grating pattern and forming a superstrate layer on top of the Metasurfaces structures using material having an index of refraction lower than the second index of refraction.

35. The see-through optical combiner according to claim 24, being manufactured by a method comprising:
providing a pair of plates comprising first and second matching saw-tooth structures, respectively, wherein first and second teeth t of the first and second saw-tooth structures, respectively, are arranged in an interlaced fashion;
forming, on each tooth of the saw-tooth structures, a respective one of the Metasurface structures;
bonding the first and second saw-tooth structures thereby forming a common array of the Metasurface structures of said first and second saw-tooth structures arranged in the interlaced fashion.

36. A lens unit for use in an optical system of augmented reality glasses, the lens unit comprising: an integral structure formed by a lens having a predetermined wavefront curvature according to lens prescription, and a see-through optical combiner embedded inside the lens such that said see-through optical combiner is located in an inner part of the lens being enclosed by opposite lens segments of, respectively, front and rear parts of the lens, said see-through optical combiner comprising a plurality of partially-transparent reflectors arranged in a spaced-apart parallel relationship along said inner part and exposed to interaction with input light propagating along a first axis through said inner part of the lens and being indicative of image being projected with a certain exit pupil, said partially-transparent reflectors being inclined with respect to said first axis, such that said partially-transparent reflectors successively interact with the input light, and form light reflections therefrom, thereby providing replication of said exit pupil along a first dimension of the eyebox while maintaining said wavefront curvature of the lens.

37. The lens unit according to claim 36, wherein each of said partially-transparent reflectors comprises a Metasurface structure adapted to partially reflect a number N (N≥1) of predetermined discrete wavelengths.

38. A lens unit for use in an optical system of augmented reality glasses, the lens unit comprising: an integral structure formed by a lens having a predetermined wavefront curvature according to lens prescription, and the see-through optical combiner of claim 25.

39. The lens unit according to claim 38, being manufactured by a method comprising: providing said see-through optical combiner; and encapsulating said see-through optical combiner into the inner part of the lens to be enclosed by the opposite lens segments, said encapsulating comprising one of the following: encapsulating by gluing of the combiner between the front and back lens segments; or partially or fully encapsulating the combiner by casting or molding using a lens material.

40. The lens unit according to claim 39, wherein said providing of the see-through optical combiner comprises manufacturing the see-through optical combiner by the method according to claim 31.

41. The lens unit according to claim 39, wherein said providing of the see-through optical combiner comprises manufacturing the see-through optical combiner by the method according to claim 33.

42. The lens unit according to claim 39, wherein said providing of the see-through optical combiner comprises manufacturing the see-through optical combiner by the method according to claim 34.

43. The lens unit according to claim 39, wherein said providing of the see-through optical combiner comprises manufacturing the see-through optical combiner by the method according to claim 35.

44. The lens unit according to claim 38, being manufactured by a method comprising:
manufacturing a plurality of plates made of a lens material, each carrying an array of Metasurface structures with a predetermined distance between adjacent Metasurface structures, and a predetermined distance of the array of the Metasurface structure from an edge of a respective one of said plates;
stacking the plurality of said plates and bonding them together to form a bonded stack;
slicing said bonded stack along a cut axis inclined at a predetermined angle with respect to a Metasurface plane, into a plurality of lens plates;
applying a surface treatment to each of the lens plates to obtain a predetermined wavefront curvature of the lens.

45. The lens unit according to claim 38, being manufactured by a method comprising:
providing a pair of plates made of a lens material and corresponding to the opposite segments of the lens, said pair of plates comprising first and second matching saw-tooth structures, respectively, wherein first and second teeth of the first and second saw-tooth structures respectively are arranged in an interlaced fashion;
forming, on each tooth of the saw-tooth structures, a respective one of the Metasurface structures;
bonding the first and second saw-tooth structures thereby forming a common array of the Metasurface structures of said first and second saw-tooth structures arranged in the interlaced fashion.

46. The lens unit according to claim 45, wherein said pair of plates are configured in accordance with the predetermined wavefront curvature of the lens.

47. The lens unit according to claim 45, wherein said method further comprises applying a surface treatment to the pair of plates to obtain a predetermined wavefront curvature of the lens.
